(19) United States
(12) Patent Application Publication
(10) Pub. No.: US 2006/0085272 A1
(43) Pub. Date: Apr. 20, 2006

(54) System and method for facilitating determination and evaluation of and placing orders for nutritional blend formulations

(76) Inventors: James Andrew Case, Sparta, NJ (US); Raymond Alistair Jones, Alberta (CA); Somashekhar Venkatanarayan, Kloten (CH)

Correspondence Address: Stephen M Haracz;Bryan Cave, 1290 Avenue of the Americas, New York, NY, 10104, US

(21) Appl. No.: 10/513,849

(22) PCT Filed: May 5, 2003
(86) PCT No.: PCT/EP03/04683

§ 371 Date: Nov. 25, 2005

Related U.S. Application Data
(60) Provisional application No. 60/378,719, filed on May 7, 2002.

(51) Int. Cl. G06Q 30/00; G09B 19/00

(52) U.S. Cl. 705/26; 434/127

(57) ABSTRACT

System and method are disclosed for helping users determine, evaluate, and/or place orders for nutritional blend formulations to be manufactured from available nutritional formulation materials. A web-accessible graphical user interface receives specifications from a user for a nutritional blend formulation (e.g., intended use, desired nutritional activity, and/or concentration of nutrients in the formulation). Information concerning the available nutritional formulation materials are organized into hierarchies that facilitate identifying the available nutritional formulation materials for preparing the formulation. The system converts the specifications into information reported to the user. The user can modify the specifications to determine the effect on the reported information (e.g., cost), and such modifications can be made repeatedly until the user is satisfied. The user can submit the proposed formulation to the manufacturer or vendor to allow them to review, approve, or modify the formulation. After everyone is satisfied, the user can place an order for the formulation.

### FIELD OF THE INVENTION

The present invention relates to the field of computer systems and methods and more particularly to a web-based system and method for assisting users to determine, evaluate, and/or place orders for nutritional blend formulations.

### BACKGROUND OF THE INVENTION AND OTHER INFORMATION

Developing an effective and economic blend of nutrients to be used in, for example, animal or human food requires considerable expertise. Nutrients that may be included, such as vitamins and minerals, are often available in many different forms. The physical, chemical, and biological properties of the nutrients and the forms in which they are available (i.e., the nutritional formulation materials) determine in which blends they can be used as well as the safety, efficacy, cost, etc. of the blends.

Manufacturers or vendors of the blends and of the available nutritional formulation materials from which they are made may suggest minimum or maximum levels for concentration, nutritional activity, and/or other properties depending on the intended usage of the blends or nutritional formulation materials. Limitations on or even exclusions of particular materials may also stem from government or other regulatory rules or even the customs of an industry. Applicable limitations and exclusions must be considered in developing a safe and effective blend formulation product.

Specifications set by customers ordering nutritional blend formulations must be matched to the available nutritional formulation materials (i.e., the ingredients) from which the nutritional blend formulations will be made. This goes beyond mere conversion of metric to English units or vice versa and must include selecting the particular available nutritional formulation material that will supply each nutrient and then converting the desired number of International Units or weight percentage for each nutrient to the required mass of the respective nutritional formulation material. Because each nutrient may be able to be provided by a variety of different nutritional formulation materials and each nutritional formulation material has its own particular attributes (e.g., concentration and activity of nutrient, reactivity with other nutritional formulation materials, particle size distribution if the nutritional formulation material is particulate, solubility), selecting the nutritional formulation material to use to supply each nutrient may not be simple. The day-to-day availability of the nutritional formulation materials for each nutrient and their cost also need to be considered in the selection process. Even after selecting on a preliminary basis each of the nutritional formulation materials from which to make the nutritional blend formulation, it may be necessary or desirable to check for potential problems arising from, for example, interactions between the ingredients, potential solubility problems if the nutritional blend formulation is to be a liquid, potential maldistribution of one or more particulate ingredients if their particle sizes distributions are not compatible with those of the other ingredients, etc. Furthermore, the specifications for a nutritional blend formulation provided by a potential customer may be deficient or ill-suited for the intended use of the formulation, and the manufacturer or vendor may wish to so advise the potential customer or even suggest how to remedy the problem.

Therefore, determining a satisfactory nutritional blend formulation requires specialized expertise. Previously, these blending determinations were made by nutritional and related professionals in a time-consuming process that required substantial specialized knowledge in many areas, for example, of the suitability of nutritional blend formulations for particular uses, of the availability, concentration, activity, and cost of the various potential nutritional formulation materials, and of potential interactions between them. Although certain aspects of these determinations may have been previously made by or through a computer, near to or remote from potential customers, providing these determinations to potential customers promptly and accurately, thereby allowing potential customers to explore making changes in the desired nutritional blend formulations, has been a challenge. Thus, as far as is known, there is no readily available practicable system allowing a user (e.g., a potential customer) to rapidly determine (e.g., develop) and evaluate a particular nutritional blend formulation and review alternative potential nutritional blend formulations at the user's convenience and with the requisite level of interactivity.

Providing up-to-date, accurate, and clearly presented information to potential customers is vital to establishing and maintaining a business relationship between customers (potential or actual) and nutritional manufacturers and vendors. Nonetheless, whereas some other transactions are readily adapted to an e-commerce setting, such as shopping for toys, books, and even second hand articles in an interactive auction, more complicated business models, for instance, involving the development of technical specifications and the automated tailoring of data to known parameters, permissible under applicable legal requirements and applicable scientific principles, has proved more difficult to reflect in an interactive system.

Thus, the need remains for integrated, accurate, convenient to use, reliable systems and methods for determining (e.g., developing) nutritional blend formulations. Furthermore, the need remains for such systems and methods for evaluating such blends, and the need also remains for such systems and methods that can facilitate the placement of orders for such blends. The need also remains for such systems and methods that can maintain on a current basis the technical and other information (e.g., available quantities) for the nutritional formulation materials that are available for the nutrients of interest, that can evaluate proposed specifications for nutritional blend formulations in view of the intended uses of the blends, that can recommend specifications for nutritional blend formulations based on intended uses, that can select the nutritional formulation material from those that are available for each nutrient to meet the specifications, and/or that can evaluate a group of nutritional formulation materials for various types of compatibility.

### SUMMARY OF THE INVENTION

Systems and methods that satisfy those needs and provide still other benefits have now been developed. Broadly, in one aspect the present invention concerns a computerized system for assisting users to determine, evaluate, and/or place orders for nutritional blend formulations to be manufactured from available nutritional formulation materials, each nutritional blend formulation comprising a plurality of nutrients, the system comprising: (a) a web-accessible graphical user interface (i) for receiving from a user, and communicating over the web to one or more other parts of the system, specifications for a nutritional blend formulation, the specifications including the intended use of the formulation from among a plurality of possible intended uses and/or the desired nutritional activity and/or concentration of one or more of the nutrients in the formulation, and (ii) for receiving through the web from one or more other parts of the system, and reporting to the user, formulation product information determined by one or more other parts of the system pertaining to that nutritional blend formulation; (b) one or more databases of information pertaining to the available nutritional formulation materials from which the nutritional blend formulations can be prepared, the one or more available nutritional formulation materials for each nutrient being organized into a hierarchy of types and optionally one or more subtypes within each type, the hierarchy of types and subtypes facilitating the identification of the available nutritional formulation materials for the nutritional blend formulation specified by the user; (c) identification means for identifying, using the hierarchy of types and subtypes, the available nutritional formulation materials from which the nutritional blend formulation specified by the user can be manufactured; (d) retrieval means for selectively retrieving from the one or more databases at least some of the information pertaining to the available nutritional formulation materials identified by the identification means; (e) conversion means for converting the specifications into formulation product information pertaining to the nutritional blend formulation using the retrieved information, the conversion means including means for determining the quantities and/or activities of the available nutritional formulation materials to be included in the nutritional blend formulation needed to satisfy the specifications specified by the user; and (f) a reporting module for reporting the formulation product information, including the quantities and/or activities determined by the conversion means, through the graphical user interface to the user.

In another aspect, the invention concerns a computerized method for assisting users to determine, evaluate, and/or place orders for nutritional blend formulations to be manufactured from available nutritional formulation materials, each nutritional blend formulation comprising a plurality of nutrients, the method comprising the steps: (a) having available for use a system of the invention; (b) through the web-accessible graphical user interface (i) receiving from a user, and communicating over the web to one or more other parts of the system, specifications for a nutritional blend formulation, the specifications including the intended use of the formulation from among a plurality of possible intended uses and/or the desired nutritional activity and/or concentration of one or more of the nutrients in the formulation, and (ii) receiving through the web from one or more other parts of the system, and reporting to the user, formulation product information determined by one or more other parts of the system pertaining to that nutritional blend formulation; (c) identifying, using the identification means and the hierarchy of types and subtypes, the available nutritional formulation materials from which the nutritional blend formulation specified by the user can be manufactured; (d) selectively retrieving from the one or more databases of information pertaining to the available nutritional formulation materials at least some of the information pertaining to the available nutritional formulation materials identified in step (c); (e) converting the specifications into formulation product information pertaining to the nutritional blend formulation using the information retrieved in step (d), the formulation product information including the quantities and/or activities of the available nutritional formulation materials to be included in the nutritional blend formulation needed to satisfy the specifications specified by the user; and (e) reporting the formulation product information determined in step (e) through the graphical user interface to the user.

In preferred embodiments, the system can identify and provide to the user a group of suggested nutrients for each of several possible intended uses; after the user indicates a particular intended use for the nutritional blend formulation, the system presents to the user through the graphical user interface a list of the suggested nutrients for that intended use; the system does not allow the user to specify the presence of any nutrient not in the list of nutrients suggested by the system for the intended use of the nutritional blend formulation; the system contains one or more databases containing suggested minimum and/or maximum concentrations and/or activities for one or more of the nutrients for each of one or more of the intended uses; the system contains means for notifying the user through the graphical user interface if the desired nutritional activity and/or concentration for one or more of the nutrients are below the suggested minimum or above the suggested maximum concentration or activity for one or more of the nutrients for the intended use; the system contains means to communicate to the user at least a portion of the hierarchy of the available nutritional formulation materials for one or more of the nutrients in the nutritional blend formulation; the system contains means to allow the user to modify the hierarchy of the available nutritional formulation materials for one or more of the nutrients; the databases of information concerning the nutritional formulation materials are modifiable (e.g., to keep the availability of and specifications for each nutritional formulation material up to date); the specifications received from the user for the nutritional blend formulation can be modified by the system (e.g., if the user specifies an activity, for an nutrient that is below the suggested minimum activity for that nutrient for the intended usage) or by the user (e.g., to allow the user to determine the effect of changing one or more specifications or the hierarchy); the system contains means for determining the estimated cost of the nutritional blend formulation (e.g., based on the original specifications or on modified specifications) and reporting the cost to the user; the system contains means for reviewing the specifications received from the user (e.g., the desired nutritional activity and/or concentration of the nutrients in the nutritional blend formulation) for compliance with regulatory agency regulations and/or for consistency and/or completeness and/or compatibility and for notifying the user of the results of the review; the system contains means for estimating one or more physical properties of the proposed nutritional blend formulation (e.g., the particle size distribution of the particles in the nutritional blend formulation); the system contains means to allow the user to approve the nutritional blend formulation (e.g., based on original or modified specifications) for manufacture; the system contains means for allowing review of the nutritional blend formulation after it has been approved for manufacture; and/or the system contains means to transmit the nutritional blend formulation and/or its corresponding formulation product information to another system (e.g., a manufacturing control system or an enterprise system) to allow the nutritional blend formulation to be manufactured.

The terms “nutrient,” “nutrients,” and the like should be understood broadly and include not only vitamins and minerals but also other substances that are now or may in the future be necessary or recommended for ingestion for nutritional reasons (e.g., fiber, phytochemicals, enzymes, yeast, bacteria). A “nutritional blend formulation” is any formulation containing one or more nutrients and a plurality (i.e., two or more) of nutritional formulation materials that can be combined in response to specifications received from a user via a system or method of this invention. The term “nutritional formulation materials” should be understood broadly and includes the various ingredients that can be combined to produce a nutritional blend formulation. A nutritional formulation material may contain one or more nutrients or it may be only a carrier (e.g., adjuvant, anti-caking agent, dispersing agent, anti-oxidant, surfactant, solvent, colorant) and not contain any nutrients. Thus, a nutritional blend formulation may result from combining as few as two nutritional formulation materials, one of which contains only a single nutrient and the other of which is a carrier, or it may result from combining two dozen or more nutritional formulation materials, each of which contains at least one nutrient.

The terms “specifications,” “specification,” and the like should be understood broadly. With respect to the nutritional blend formulation, the specifications may include the intended use of the formulation from among a plurality of possible intended uses and/or the desired nutritional activity and/or concentration of one or more of the nutrients in the formulation, as well as other information such as the physical form of the nutritional blend formulation (e.g., particulate, liquid), the type and size of container in which the nutritional blend formulation is to be shipped (e.g., railroad tank car for a liquid, fifty-pound bags for a particulate), the total amount of nutritional blend formulation to be purchased, etc. A user may provide the system with (i.e., enter) only one specification for a nutritional blend formulation, namely, the intended use (e.g., a premix to be added to feed for chickens intended to be sold as fryers), and allow the system to propose the nutrients to be present in the nutritional blend formulation and their concentrations, or the user may specify an intended use for the nutritional blend formulation and some or all of the nutrients, or the user may specify an intended use for the nutritional blend formulation and some or all of the nutrients as well as some or all of the activities and/or concentrations in the nutritional blend formulation of the nutrients.

The method of the present invention may be conducted over or through, and the system of the present invention may be implemented by means of or using, a public or private communications connection (e.g., link, system), for instance, the Internet, using a graphical user interface for the entry and receipt of specifications (e.g., information concerning the intended uses of the nutritional blend formulations, technical specifications) by a user to facilitate the determination and/or evaluation of and/or placement of orders for nutritional blend formulations and for the system to report to the user the formulation product information determined by the system. The term “web-accessible” should be understood broadly and includes any communications connection that can directly or indirectly access a private or public web (e.g., the “World Wide Web”) for the entry and receipt of data (“data” and “information” are used interchangeably herein).

The terms “user,” “users,” and the like when referring to a user of the systems and/or methods of this invention should be understood broadly and refer to individuals, organizations, and to automated tools for the entry and receipt of information over communications connections. The automated tool may be a local computer system, network, or node utilized by any user interested in or concerned with the nutritional blend formulations. Thus, a user may be an individual who on behalf of a company for which he or she works enters specifications on his or her home or office computer or input/output device for a nutritional blend formulation the company is considering adding to a food product it manufactures for resale (e.g., livestock feed, breakfast cereal for humans) or uses internally in its own operations (e.g., animal husbandry).

The terms “communicating,” “communicate,” “communicates,” “communication,” and the like should be understood broadly and refer to any transmission, forwarding, relay, cooperation, or other means of associating the various functionalities or components of the system with respect to the data (e.g., information such as specifications) upon or with which they act or of associating the user and input received from the user with the various functionalities or components of the system with respect to the data (e.g., information such as specifications) upon or with which they act. For example, the user may communicate with the system through public or private telephone lines and/or optical transmission and/or microwave transmission, and the different parts of the system may communicate with each other through public or private telephone lines and/or optical transmission and/or microwave transmission or those parts of the system in close proximity may even be hard-wired together. Similarly, the term “reporting to the user” should be understood broadly and includes any transmission, forwarding, relay, cooperation, or other means of imparting to the user the formulation product information determined by the system.

As used herein, “determine,” “determination,” and the like should be understood broadly and refer to all aspects of determining (e.g., developing, deciding upon, establishing) a nutritional blend formulation. Similarly, “evaluate,” “evaluation,” and the like should be understood broadly and refer to all aspects of evaluating (e.g., investigating, testing, appraising, judging, considering) a nutritional blend formulation. Finally, “place orders for,” “placing orders for,” “placement of orders for,” and the like should be understood broadly and refer to all aspects of buying, offering to buy, or inviting an offer to sell a nutritional blend formulation or any of the stages leading up to any of the foregoing.

The term “formulation product information” should be understood broadly and will typically include an identification of the nutrients and/or nutritional formulation materials in the nutritional blend formulation and their quantities and/or activities and may also include the name or other identification assigned to the nutritional blend formulation (e.g., by the user) as well as an identification of the physical form of the nutritional blend formulation, estimates of various physical properties of the formulation, and/or information concerning its packaging, estimated delivery time, and/or estimated cost.

The present invention provides systems and methods that are accurate, convenient to use, and reliable for facilitating the determination of, the evaluation of, and the placement of orders for nutritional blend formulations, and these systems may be connected to other systems inside or outside of the enterprise that provides the systems of this invention. The systems of this invention can maintain on a current basis the technical and other information for the nutritional formulation materials that are available for the nutrients of interest, can evaluate proposed specifications for nutritional blend formulations in view of the intended uses of the blends, can recommend specifications for nutritional blend formulations based on intended uses, can select the nutritional formulation material from those that are available for each nutrient to meet the specifications, and/or can evaluate a group of nutritional formulation materials for various types of compatibility. Further features and advantages of the invention will be apparent to those skilled in the art.

### BRIEF DESCRIPTION OF DRAWINGS

To facilitate further description of the invention, the following drawings are provided in which:

FIG. 1 is a block diagram of the components of the preferred system of this invention;

FIG. 2 is a block diagram of the graphical user interface of the preferred system;

FIG. 3 is a block diagram of the one or more databases of the preferred system;

FIG. 4 is a block diagram of the database interaction component of the preferred system showing its interaction with the one or more databases;

FIG. 5 is a block diagram of the processing component of the preferred system;

FIG. 6 is a flow chart illustrating the preferred method of the invention, which method utilizes the preferred system; and

FIGS. 7a-7t are screen prints of web pages according to a preferred implementation of the system and method of this invention.

These drawings are provided for illustrative purposes only and should not be used to unduly limit the scope of the invention.

### DETAILED DESCRIPTION OF THE INVENTION

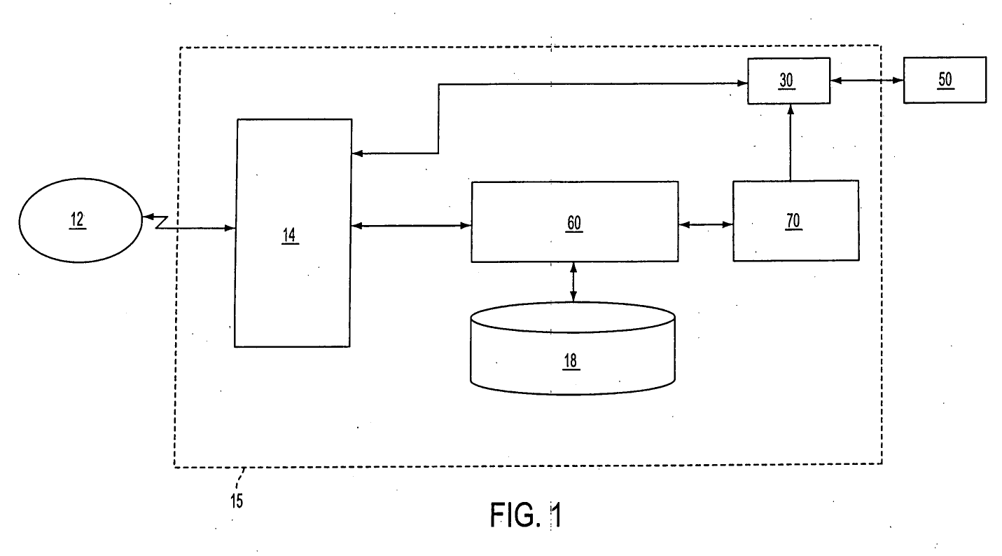

In FIG. 1, the blocks correspond to components of system 15. “Components” are groupings of functions (in this case, functions performed by system 15). Referencing grouping of functions as “components” or by the names given to the components is for purposes of convenience, and the drawings merely show one manner of grouping the various functions of the invention; however, the invention is not limited to any particular grouping and any grouping of functions that meets the limitations of the claims may be used. For example, the components and the functions they encompass may reside in a single computer system or multiple computer systems or be otherwise organized within a system or systems and may be close to or remote from one another. Moreover, the functions described herein may be in addition to other functions of the system or systems not described herein, or the functions described herein may be exclusive of other functions.

Each identification herein of particular components or functions performed by the system for doing something or of steps performed in the course of carrying out a method, whether or not expressly recited in connection with a “means” for performing those functions (e.g., “conversion means for converting the specifications into formulation product information . . . ”; “a web-accessible graphical user interface (i) for receiving from a user, and communicating over the web . . . specifications . . . and (ii) for receiving through the web . . . and reporting to the user, formulation product information . . . ”), refers to and encompasses all possible embodiments, structures, and steps for performing the function(s), including various possible architecture and programming formats. These functions may be provided and performed through the use of various components, computers, and other elements and techniques, including hardware, firmware, software, databases, modules, routines, programs, algorithms, engines, plug-ins, or other structures within a computer or system that may be used to provide and/or perform the particular function(s) identified. Coding, devising these structures, and devising their architecture are a matter of design choice and are well within the ordinary skill of the art. Moreover, combining or separating one or more functions in or between various components, computers, systems, programs, or program subunits may be accomplished by methods known in the art.

Therefore, the functions identified herein (e.g., in the figures) as within the components of system 15 may also be independent of the particular components identified and may be interrelated and/or accessible to the user through various interconnections or otherwise networked in ways known to the art. Each of the functions and components may be close to or remote from one another, either geographically or within a host structure. As noted above, the consolidation of the various functions of the system into the components identified herein is to illustrate the functions and their cooperation and interaction and does not and should not be understood to limit the location of these functions to being within particular components or to limit the location of these components to being within particular structures.

System 15 assists users to determine, evaluate, and/or place orders for nutritional blend formulations to be manufactured from available nutritional formulation materials. As explained above, each nutritional blend formulation is composed of one or more nutrients and a plurality of nutritional formulation materials. System 15 encompasses functionalities and components interacting and/or cooperating in the processing of data (e.g., information such as specifications for the nutritional blend formulation). Using a communications network, preferably the Internet, a connection between system 15 and a local node 12 of a user is established, preferably over the “World Wide Web” or other computer network, which network is preferably but not necessarily global and which network may or may not be accessible by the public at large (for convenience the term “web” is used herein to refer to a communications network).

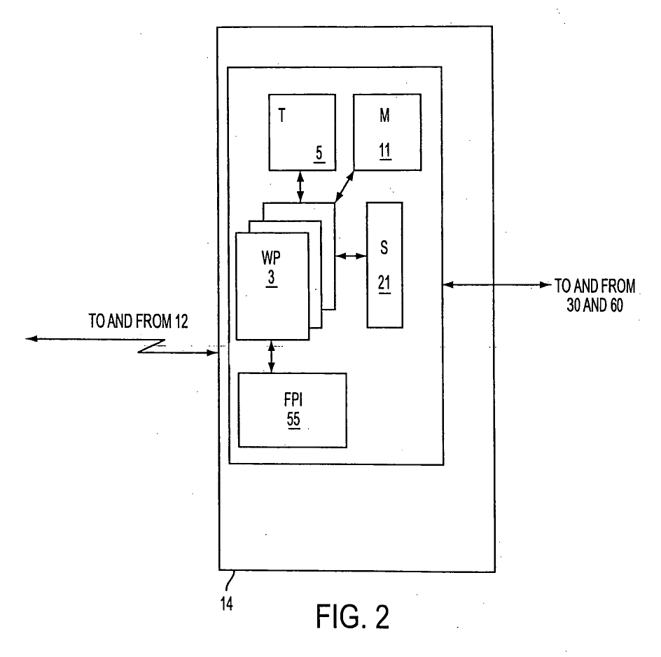

System 15 is accessed using local node 12, which may be a single computer or a network of computers available to a particular user for the entry and receipt of information over the web. System 15, which is visible to the user in the form of an on-line service offered either directly or through an Internet Service Provider (“ISP”) by a manufacturer, vendor, or other source of nutritional blend formulations (or an agent or broker of any of them), maintains web pages 3 (FIG. 2), which constitute at least a portion of a graphical user interface 14 that may be accessed, downloaded, connected to, displayed, and/or otherwise received at local node 12 and that communicates with system 15 over the web. The preferred embodiment of system 15 is therefore “web based” and may involve the local node 12 launching a web browser or other program to locate, contact, and send and receive data from system 15, where system 15 may be located at one or more remote locations. System 15 may also be accessible through other communication network structures (webs), such as an Intranet system. System 15 may be implemented through one or more servers or groupings of servers or other host computer systems having programs, modules, or other processing units accessible to a user operating local node 12.

System 15 components include graphical user interface 14, one or more databases 18, database interaction component 60, processing component 70, and reporting module 30. The functionalities within graphical user interface 14 receive data from and output data to the user (e.g., specifications and formulation product information concerning the nutritional blend formulation). The graphical user interface (i.e., the functionalities within the graphical user interface) communicates with other portions of system 15 as follows. Based on specifications provided to the system by the user through graphical user interface 14 regarding a desired nutritional blend formulation, database interaction component 60 identifies and retrieves information from data structures within the one or more databases 18. Database interaction component 60 then communicates the information retrieved from the one or more databases 18 to processing component 70, where the specifications are processed (converted) using the retrieved information into formulation product information according to functionalities contained in processing component 70. Reporting module 30 receives the formulation product information from the processing component 70 and reports it back to graphical user interface 14 and to other computer networks or other systems 50 that may be linked to system 15. Local node 12 accesses/displays the formulation product information for the user.

FIG. 2 illustrates the functionalities encompassed by graphical user interface 14. Graphical user interface 14 encompasses web pages 3, which are accessible to the user on local node 12 using, for instance, a local web browser program, as well as other supporting programs, tools, and software needed to enable communication and interaction between the user and system 15 through local node 12. Thus, graphical user interface 14 is the point of interactivity between local node 12 and the rest of system 15 and its various other components and functionalities, allowing a user to enter, modify, and receive information. Preferably, graphical user interface 14 provides web pages 3 in appropriate graphical formats for the user's entry and receipt of information, which formats may include one or more templates, pull-down menus, selection fields, input fields, text area fields, dialog boxes, and/or other modes and structures to receive data from or display data to a user.

Modification means 11 allows a user to modify information entered into any of these structures or otherwise into web pages 3, for instance, using a modification mode that saves current information input by the user and allows additions to that information in increments, saving each incremental step. Modification may be accomplished in other ways, including by typing over or retyping information previously input by the user into web pages 3. Other forms of entry, receipt, modification, display, and organization of information are also within the scope and contemplation of the graphical user interface 14, for instance, using various coded, encrypted, digitized, and/or notational formats to input, transmit, and/or output information.

According to the preferred embodiment, using local node 12 a user inputs specifications 21 into one or more web pages 3, the specifications 21 being for the nutritional blend formulation. The specifications 21 are communicated by graphical user interface 14 over the web to one or more other parts of the system 15. The specifications 21 provide information used by system 15 to identify suitable available nutritional formulation materials for use in the nutritional blend formulation. The specifications 21 may include, for instance, one or more intended uses of the formulation (for example, from among a plurality of possible intended uses that may be presented to the user through web pages 3), and/or one or more particular nutrients, and/or one or more desired nutritional activities and/or concentrations of one or more of the nutrients in the formulation. Intended use of the nutritional blend formulation may be identified according to the intended ultimate consumer of the formulation, e.g., particular animal, species, or sub-species, and/or intended purpose of the formulation, e.g., promote animal growth, impart resistance to disease, reduce fat content, or increase milk yield. Activities and/or concentrations of nutrients in the nutritional blend formulation may be expressed by a user in the specifications 21 using appropriate units of measure, for instance International Units appropriate for the particular nutrient, units of mass (whether standard metric, English, or other), or percentage of the nutrient in the overall nutritional blend formulation. The specifications 21 may also include user information pertaining to packaging, shipping, batch size, and/or quantity. The user can specify the applicable units of measure for the specifications 21, for instance, from a selection field, pull down menu, or in any other appropriate manner. The graphical user interface may allow “free form” entry of some or all of the data.

The web pages 3 on graphical user interface 14 may also display suggested particular nutrients to a user based on the input of an intended use in the specifications 21. If the user inputs only an intended use for the nutritional blend formulation, the system can suggest the nutrients and quantities/activities appropriate for that use. Template 5 on graphical user interface 14 comprises one or more interactive templates in which the intended usage may be selected from a list of a plurality of intended uses, for instance, displayed through template 5 on web pages 3. In response to specification of this intended use, template 5 may list suggested nutrients from which the user may select. The system may or may not allow the user to add additional nutrients to those suggested by the system.

Template 5 may interactively reference suggested nutrients in response to the selection of a particular intended use and display them, for instance, via a customizable select field HTML tag linked through an applet launched by the web browser. There are other ways in which a group of nutrients for the specified use may be suggested to the user. For example, template 5 may receive a list of suggested nutrients from a database within the system retrieved through a search of nutrient data. In any case, suggested nutrients may also have suggested minimum and/or maximum quantities or activities associated with them for various nutritional blend formulation uses, and those minimum and/or maximum values may be presented to the user on the web pages 3 to assist in completing the specifications 21. Some or all of those values may normally be hidden to the user and displayed to the user only when the specifications input by the user are or would result in values for nutrients above the respective suggested maximums or below the respective suggested minimums. The system may also prevent the user from entering a value for a nutrient into web pages 3 outside of the suggested values for that nutrient (i.e., below the suggested minimum or above the suggested maximum).

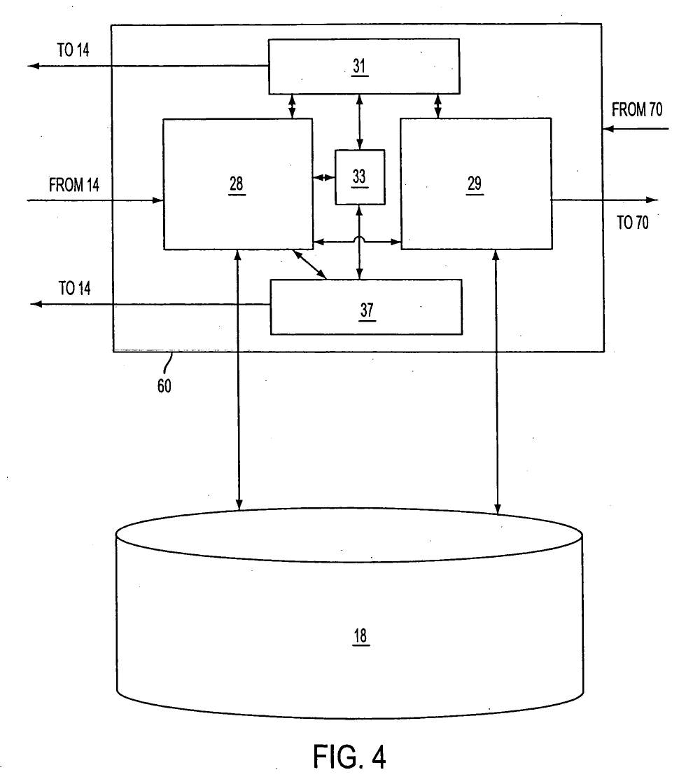

Template 5 may comprise a plurality of templates or displays employed by a user to interactively select or specify further aspects of specifications 21, in “free form” (e.g., in plain text and in any order) and/or from discrete alternatives presented. For example, after the name of a particular nutrient is input in free form, selected by the user from a menu, or by some other means, template 5 may display various additional information for the nutrient, for example, the “type” of the nutritional formulation material that will supply the nutrient, and the user may be allowed to further specify relevant information about the nutritional formulation material. There will often be many different nutritional formulation materials that can supply a nutrient, each possibly having different physical, chemical, and biological properties. Thus, for example, after a particular nutrient is specified, the user may be given the opportunity to specify the chemical and/or physical form for the nutritional formulation material that will supply the nutrient (e.g., as a salt or an ester; as a solid particulate or a liquid), the concentration or activity of the nutrient per mass of nutritional formulation material (e.g., International Units per microgram), the other ingredients besides the nutrient in the nutritional formulation material, etc. The “type” information for the nutritional formulation materials presented via one or more web pages 3 may be linked directly to a particular nutrient identified by the user or may be identified and retrieved from a database in response to the specifications 21 and then communicated to the user using notification means 37 (FIG. 4).

There may be several hierarchical levels of type information. For example, after the user specifies that the desired nutritional formulation material to be used to supply a nutrient is particulate, information from the next lower hierarchical level (e.g., values characterizing the particle size distribution of each available nutritional formulation material, such as mean particle size, minimum size, maximum size, and standard deviation), i.e., “subtypes” within the particulate “type,” may be displayed to the user to allow the user to select from among several different particle size distributions (i.e., to select from among the particulate “subtypes”). There may be additional lower hierarchical levels, and the terms “types,” “subtypes,” and “hierarchy of types” should be understood to refer to these one or more hierarchical levels of information, at least some of which may be displayed to the user.

In response to specifications 21 submitted by a user, one or more other parts of system 15 develop a proposed nutritional blend for the user's review and approval. This proposed blend is characterized by formulation product information 55 pertaining to a particular proposed nutritional blend formulation. Formulation product information 55 is received by the graphical user interface 14 and is reported to the user, for instance, by inclusion of the formulation product information on one or more web pages 3. Formulation product information may contain an estimate of the cost of the formulation, various estimated physical properties of the formulation, information concerning expected delivery schedule for the formulation, etc. in addition to a detailed breakdown (nutrient by nutrient) of the concentration/activity of each nutrient within the nutritional blend formulation.

After the formulation product information produced by the system corresponding to the specifications 21 input by the user is considered by the user, the user may wish to modify those specifications (e.g., to see if selecting a different particulate nutritional formulation material to supply a particular nutrient would change the estimated price of the nutritional blend formulation), and those specifications may be modified by the user through modification means 11 within graphical user interface 14, and resubmitted to system 15. Modification by the user may take place, for instance, by making modifications one at a time, for instance, changing the nutritional activity of a nutrient, or by making several at a time (e.g., adding a nutrient and changing the concentration of another nutrient). Changes due to the one or more modifications will be reflected in the new formulation product information 55 received by the user via graphical user interface 14 after the modified specifications 21 are processed by system 15.

The system may also automatically or with permission of the user, ranging from blanket permission (i.e., carte blanche) to specific (e.g., instance by instance) permission, make modifications in the specifications. For example, if for a particular intended use of the nutritional blend formulation, the activity level for a nutrient specified by the user is below the minimum activity level recommended or suggested by the system, the system may automatically or with permission of the user increase the level of the nutrient in the specifications to at least the recommended minimum activity level. In that situation, the system could present the formulation product information for the originally specified formulation and for the modified specifications to the user, or the system could present only the formulation product information for the modified specifications to the user. In either case, the system could include in the formulation product information presented to the user a notation indicating that the activity level for the nutrient was below the recommended minimum and that it had been increased for the modified specifications.

Returning now to the start of the process so that additional behind-the-scenes operation of the system (i.e., the operations that the user does not see) can be described, once a user has provided specifications 21 (original or modified) for a nutritional blend formulation through web pages 3 via the graphical user interface 14, these specifications 21 are communicated over the web to other parts of system 15 to be further processed by other functionalities within components of system 15.

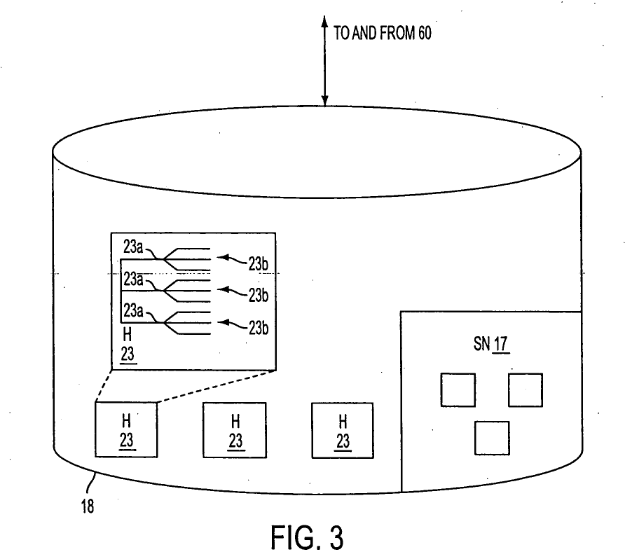

FIG. 3 illustrates the functionalities encompassed by one or more databases 18 within system 15. The one or more databases 18 store information pertaining to available nutritional formulation materials from which the nutritional blend formulations may be prepared. System 15 may include means for modification (not pictured) of the information and/or its organization within the database, either by a user through the graphical user interface 14 or by the system 15 (automatically or otherwise).

The information may be in various document forms or other forms for saving, organizing, modifying, searching, and retrieving data. Preferably, the information (data) is in Extensible Markup Language (“XML”) format, but any other appropriate format may be used. XML format provides advantages including ease of organization, reading, parsing, retrieval, and compatibility with other software systems and platforms and allows for modification of the data stored in this format. Thus, the information may be in a tree-type data structure in an extensible markup language (XML) document format hierarchy wherein the documents are linked to (through, for instance, XLink), pointed to, or tagged through a schema language such as Document Type Definition (DTD).

Information pertaining to the available nutritional formulation materials for each nutrient are contained in one or more database elements, which may be documents, tables, vectors, matrices, or any other scheme, organized into a hierarchy 23 of types 23a and optionally one or more subtypes 23b within each type. Hierarchies 23 of types 23a and subtypes 23b for nutrients within the one or more databases 18 facilitate, identification of the available nutritional formulation materials in order to determine their suitability for a nutritional formulation blend according to specifications 21 as originally received or as modified (in other words, to determine which nutritional formulation material to use to supply each nutrient in the nutritional blend formulation). The hierarchies (one for each nutrient) are organizations or arrangements of information pertaining to the vitamins, minerals, and other nutrients that incorporate not only their designations and broad classifications but also the designations, classifications, and information concerning the nutritional formulation materials that can be used to supply the nutrients to be present in the nutritional blend formulation. The designation, classification, and other information concerning each nutritional formulation material may reflect the available raw materials used to make it and will reflect its physical form (e.g., whether it is liquid or dry), nutritional activity, reactivity with other nutrients, etc.

In hierarchies 23, vitamins, minerals, or other nutrients may be indicated, but each may have numerous forms, e.g. reflecting its formulation and/or the various raw materials used to produce it. Within these forms, there also may be numerous discernible “types,” e.g., based on their having different levels of nutritional activity (e.g., International Units per unit mass) or whether they are particulate or liquid. Moreover, within these types, there also may optionally be “subtypes” which, for instance, may indicate further attributes of the nutrients in their commercially available forms (i.e., as the nutritional formulation materials). These “subtypes” may reflect properties that are unique to the particular commercial form of the nutrient (i.e., the specific nutritional formulation material) available to the manufacturer or already in the manufacturer's inventory. For example, classification of subtypes may be based on the manufacturing lot or batch, plant where produced, price, ability to be shipped within a particular period of time, or other considerations relating to their availability. Utilizing a tree-type data structure, the types and subtypes of nutritional formulation materials for each nutrient may be organized, modified, and/or accessed.

By way of example, vitamin A may have multiple forms, which may be differentiated based on, among other criteria, their raw material formulation, and/or the presence of other nutrients in the nutritional formulation material containing the vitamin. Taking a specific form of vitamin A, for instance, dry vitamin A acetate, there may be different types. One type may have 750,000 International Units/gram, may be particulate, water-insoluble, and be suitable for pre-mixes and compound feeds. Another type of vitamin A may have 500,000 International Units/gram, may be particulate, water-soluble, and be suitable for milk replacements and liquid diets. For each type of Vitamin A, there may be one or more subtypes that may be coded internally by the manufacturer or vendor that reflect particular forms available from the manufacturer. Some subtypes 23b at the lot (or batch) level may deviate slightly from the type 23a in activity or other physical properties from the nominal type values (i.e., 750,000 or 500,000 International Units/gram). These and other attributes may be reflected in the designation of subtypes 23b.

As another example, under the nutrient vitamin E, there may be several types at the first hierarchical level (e.g., dl-alpha tocopherol, dl-alpha tocopherol acetate, mixed tocopherols containing di-alpha tocopherol) and under each of one or more of those types at that first hierarchical level, there may be various activity levels, solubility (i.e., whether the nutritional formulation material is oil-soluble or water-soluble), kind (i.e., whether it is natural or synthetic), etc. There could in fact be several hierarchical levels under the first (uppermost) hierarchical level. It will be understood that in the hierarchy of types and optional subtypes of available nutritional formulation materials for each nutrient, below the uppermost “type” hierarchical level each lower hierarchical level may be referred to as a “type” hierarchical level or a “subtype” hierarchical level and each such lower type or subtype may itself have types or subtypes below it. The only difference between the labels “type” and “subtype” is that use of “subtype” for a given hierarchical level indicates that there is at least one hierarchical level above it.

Designations and other information for the various types 23a and optional subtypes 23b of nutritional formulation materials may be stored within the database for identification and selection either at the instruction (implicit or explicit request) of a user or through operation of the system or by a combination of both. For example, the user may select the type for a given nutrient from the first hierarchical level. If the user is allowed to see the possibilities at the next lower (second) hierarchical level for the type selected at the first hierarchical level, the user may also be permitted to select a subtype at that second hierarchical level. There may be one or more still lower hierarchical levels, and the user may or may not be permitted to see them and may or may not be permitted to make selections within those lower hierarchical levels.

For example, if vitamin E is to be present in the nutritional blend formulation, the user may chose dl-alpha tocopherol acetate at the first hierarchical level. Under that selection (i.e., di-alpha tocopherol acetate) at the first hierarchical level, there may be two possibilities at the second hierarchical level, namely, water-soluble and oil-soluble. After the user chooses one of those two subtypes, e.g., oil-soluble, the user may not see any further hierarchical levels below the oil-soluble subtype, but there may in fact be other levels below that. Thus, under the nutrient vitamin E/dl-alpha tocopherol acetate (first hierarchical level)/oil-soluble (second hierarchical level), there may be several manufacturers or suppliers at the next lower (third) hierarchical level and under each manufacturer there may be a still lower (fourth) hierarchical level, e.g., with different lots (batches). Of course, the third level could contain the lot information (e.g., designation) and there might be no manufacturer/vendor hierarchical level and there might be no other level below the lot (third) level.

As previously indicated, in some cases, the information in one or more of the hierarchical levels may not be displayed to the user or, if displayed, may not be selectable by the user. Users would not usually be shown the names of manufacturers or vendors of each of the nutritional formulation materials or the analysis of any lots. Each lot will typically have information associated with it such as its chemical analysis (including content of significant trace ingredients), unit cost, amount remaining in inventory, specific activity of the nutrient it supplies, expiration date, etc. Such information is not normally needed by a user (potential customer) and there would normally be no need to display information at that hierarchical level to the user (the information is, however, needed by the system).

After the user makes selections at the hierarchical levels above the manufacturer and/or lot level(s), the system could automatically select a manufacturer or vendor (if there were more than one) and a lot based on, for example, the age of the lot, whether the amount of the lot remaining on hand was sufficient to meet the batch size specification entered by the user, particle size distribution, or on other manufacturing considerations. If there were no manufacturer/vendor hierarchical level, the system would select the lot to use (e.g., based on the foregoing criteria). Of course, in some cases the system could allow the user to specify the manufacturer and/or particular lot to be used for each nutritional formulation material.

Rather than having the user make any selections, the user could allow or affirmatively choose to have the system make all the selections, including of the nutrients to be included in the nutritional blend formulation. Thus, after the user specified the intended use of the nutritional blend formulation, the user could allow or affirmatively choose to have the system select all the ingredients. A database of suggested nutrients 17 may be located within the one or more databases 18 (alternatively, the database of suggested nutrient could be in the graphical user interface or its local functionalities or elsewhere in system 15). For vitamin E, the system could choose to employ dl-tocopherol and for that type, the system could choose oil-soluble, and for that subtype, the system could choose the manufacturer, and for that manufacturer the system could choose to employ the oldest lot that was large enough to meet the user's batch size specification.

In any case (selections at all hierarchical levels made by the user or selections at all hierarchical levels made by the system or selections made by a combination of the two), once the lot of the particular nutritional formulation material being used to supply a nutrient is determined (selected), the physical and chemical properties of the lot, its unit cost, etc. are known and can be used by the rest of the system to convert the specifications for the desired nutritional blend formulation to the required formulation product information (e.g., quantity).

As will be understood by one skilled in the art, the nutritional formulation materials can be arranged in any hierarchical scheme that allows the benefits of the invention to be realized and the language “the one or more available nutritional formulation materials for each nutrient being organized into a hierarchy of types and optionally one or more subtypes within each type” and the like should be understood broadly to cover all such arrangements. It should also be understood by one skilled in the art that the purpose of the hierarchical scheme is to allow the user, the system, or the user and the system in combination to identify which nutritional formulation materials will be used for the nutritional blend formulation and, therefore, which nutritional formulation materials will have their respective information (e.g., activity or concentration of nutrient, unit cost) used by the system to convert the specifications (original or modified) into formulation product information. Thus, the language “the hierarchy of types and subtypes facilitating the identification of the available nutritional formulation materials for the nutritional blend formulation specified by the user” and the like should be understood broadly and should be understood to refer to that purpose.

The hierarchy will typically be configured and the information in it loaded and modified (e.g., to keep it up to date) by the one or more parties providing system 15; however, in some cases, it may be desirable to allow the user to modify the hierarchy 23 (e.g., to customize it for the user), and any suitable means may be used. For example, pull down menus or other display modes included, for instance, on template 5 of graphical user interface 14 showing the various types 23a and/or subtypes 23b may provide the means to modify portions of the hierarchy. Any modification by the user may be limited to modifying the hierarchical structure and not to modifying the information within a hierarchical level or to modifying particular information concerning one or more of the nutritional formulation materials, and the user will usually not be allowed to modify such information. The modifications by the user may be temporary (e.g., for only the session during which the modification is made) or semi-permanent (in which case the system may contain means to store and recall at a later time the modifications made by the user).

Turning now to FIG. 4, which illustrates the functionalities encompassed by database interaction component 60, after graphical user interface 14 receives specifications 21 from a user (see FIGS. 1 and 2), graphical user interface 14 communicates specifications 21 to database interaction component 60, which encompasses functionalities including identification means 28 and retrieval means 29. Based on specifications 21, identification means 28 communicates with the one or more databases 18 and identifies, using at least one hierarchy 23 of types 23a and optional subtypes 23b in the database (FIG. 3), the available nutritional formulation materials from which the nutritional blend formulation specified by the user can be manufactured. Using one or more tools, for instance Document Object Model (DOM), to read, parse, recognize, and/or process information in specifications 21, identification means 28 identifies (locates) and accesses the appropriate particular hierarchies 23 of available nutritional formulation materials in the database. Identification of the specific available nutritional formulation material to be present in the nutritional blend formulation to provide a given nutrient may accomplished by the system based on (a) the particular usage specified by the user for the nutritional blend formulation or (b) the particular nutritional activity (e.g., International Units) specified by the user or by the system based on the intended usage specified by the user and/or (c) the concentration of a nutrient specified by the user or by the system based on the intended usage specified by the user. Combinations of these specifications (usage, nutritional activity, and/or concentration) may also consulted by identification means 28.

The identification means 28 identifies nutritional formulation materials, based on the specifications, using their hierarchy 23 of types 23a and subtypes 23b. Optionally, identification means 28 may communicate with notification means 37 to contact local node 12 and the user through the graphical user interface 14 to allow the user to input additional information. For instance, information pertaining to the intended use of the nutrient formulation may be entered for the first time at this stage by the user if it has not been entered earlier, or the system may ask the user for additional information to allow the user (or the system) to choose between various types or subtypes of nutritional formulation materials for a particular nutrient. Thus, for example, the system may reach down through one or more upper hierarchical levels of nutritional formulation materials for a particular nutrient during the identification process and “discover” that further information from the user would either (a) help the system continue the identification process to make the final identification or (b) allow the user greater determination of which nutritional formulation material for providing the nutrient in question is ultimately selected. In any case, the rest of the system could contact local node 12 through graphical user interface 14 to pose one or more questions to elicit more information and allow (but not compel) the user to provide the additional information. If at any stage the user does not make a selection and/or provide all of the requested additional information, the system will make the selection and/or provide or assume the additional information based on, for example, a predetermined hierarchy and/or set of assumptions. Such a hierarchy or set of assumptions could be predetermined for all users, or it could be customized for a particular user or group of users, or it could be determined as a result of a “smart system” or “expert system” that learns from prior choices made by that user or group of users. Any method for establishing this hierarchy or set of assumptions may be employed.

A specified intended usage of a nutritional blend formulation without any specification of particular nutrients, activity levels, or concentrations may still be processed by database interactive component 60 to determine the nutritional formulation materials to be used to prepare the nutritional blend formulation. A database containing predetermined groups of suggested nutrients 17 within, for instance, the one or more databases 18, may be tied to particular usage information provided by the user at the graphical user interface 14. In other words, database 17 (which may comprise one or more databases) may contain one or more predetermined groups of suggested nutrients for each nutritional blend formulation intended use. Thus, the intended use indicated by the user through the graphical user interface 14 may trigger template communications means 31 for communicating to the user a group of suggested nutrients through, e.g., the template 5. More than one group of nutrients may be suggested by the system, and the user may be able to select which group to proceed with from among all the suggested groups. The user may be allowed to reject one or more of the suggested nutrients within a group (i.e., decide that one or more of the nutrients should not be present in the nutritional blend formulation, notwithstanding the system's recommendation that it or they be present) and/or the user may be allowed to augment the group of suggested nutrients (i.e., decide that one or more one or more additional nutrients should be present in the nutritional blend formulation, notwithstanding the system's omission of it or them from the group of suggested nutrients). Template communication means 31 (or some other part of the system) may optionally include means for preventing the user from making any such additions and/or deletions to a group of nutrients suggested by the system. These addition/deletion prevention means may be linked with or independent of notification means 37.

Database 17 (or elsewhere in the system) may contain suggested minimum and maximum concentrations and/or activities for the various suggested nutrients. Those suggested minimum and maximum concentrations and/or activities may be tied to particular intended uses (e.g., a high concentration of a nutrient in feed for one species of animal may be a normal or even an insufficient concentration in the feed for another species). Thus, there may be different minimums and/or maximums for a given nutrient depending on its intended use.

The system may present a group of suggested nutrients for the specified intended use to the user through graphical user interface 14, after which the user may be given the option of entering the desired concentration and/or activity of one or more of the nutrients in the nutritional blend formulation. The user may instead input the intended use and specify (e.g., through a template or in free form or by any other means) the desired concentration and/or activity of one or more of the nutrients in the nutritional blend formulation without the system suggesting any nutrients. In any case, the system may contain means (e.g., notification means 37) to notify the user through the graphical user interface 14 if the nutritional activity and/or concentration specified by the user for any one or more of the nutrients is below the minimum or above the maximum quantity or activity suggested by for one or more of the suggested nutrients for the intended use.

The system may recommend that certain nutrients or types or subtypes of the nutritional formulation materials that could provide those nutrients be excluded from the nutritional blend formulation or the system may absolutely bar their inclusion. The exclusion or recommendation against inclusion may or may not result from the specified intended use of the nutritional blend formulation. Exclusion may be desirable or necessary for any number of reasons (e.g., government regulations, industry recommendations, unfavorable chemical interactions between the substance in question and another substance to be included in the nutritional blend formulation or because of packaging, delivery time, price, quantity, or other specifications of the user). The function(s) of recommending against inclusion and/or of absolutely barring inclusion may reside in identification means 28 and/or elsewhere in the system.

The system may use any means of recommending against inclusion and/or of barring inclusion of a nutrient- and/or a nutritional formulation material, if those function(s) are to be included in the system. Thus, once an intended use is specified by the user, a template or other data entry means may simply not allow the inclusion of a nutrient not within the group of system suggested nutrients for that intended use. For example, after the system learns from the user of the intended use of the nutritional blend formulation, a template may be displayed on graphical user interface 14 containing the list of suggested nutrients so that the user can enter concentrations and/or activities for the nutrients, and there may simply be no place in the template to receive the names of any other nutrients.

As another example, the system may allow the user to request the presence of any nutrients the user wishes in a nutritional blend formulation, but the system may recommend that a particular nutrient not be included, for example, in view of the intended use of the nutritional blend formulation. For instance, for a particular intended use (e.g., feed for broiler chickens for human consumption), a particular nutrient (e.g., selenium) might be toxic or not yet approved for use. The system may use any suitable means for determining which substances to recommend excluding. For example, after the user requests inclusion of various nutrient in the nutritional blend formulation and specifies the intended use, identification means 28 can examine the data for each nutrient (e.g., from the hierarchy corresponding to that nutrient) and determines from that data whether any nutrient is contraindicated for that use or for inclusion with other nutrients specified by the user. If so, the system can recommend to the user through, e.g., the graphical user interface that one or more of the nutrients be removed from the proposed nutritional blend formulation, in which case the user may or may not decide to revise the specifications to remove one or more of those nutrients. Alternatively, identification means 28 can exclude one or more of those nutrients from consideration for inclusion in the nutritional blend formulation and optionally notify the user of that fact via notification means 37 through graphical user interface 14.

Identification by identification means 28 of available nutritional formulation materials for the nutritional blend formulation may be assisted by allowing for further input by the user, for example, by allowing the user to modify the specifications or by allowing the user to select the particular type or subtype of the appropriate nutritional formulation materials. At least a portion of the hierarchy 23 of the available nutritional formulation materials identified according to the identification means 28 for one or more of the nutrients in the nutritional blend formulation may be communicated to the user by notification means 37 through the graphical user interface 14. With further information displayed as to the types 23a and optionally as to the subtypes 23b of available nutritional formulation materials, the user may select particular types 23a or subtypes 23b for further processing by the system 15 for ultimate inclusion in the formulation blend.

Database interaction component 60 may also include review means 33 to review the specifications 21 received from a user with respect to requirements and regulations set by regulatory agencies pertaining to nutrients, nutritional blend formulations, and/or nutritional formulation materials. The specifications 21 received from the user may be reviewed, for example, by retrieving the appropriate information from the system's database(s) and then making the appropriate comparisons and/or the specifications may be reviewed by a program, algorithm, module, routine, or other set of instructions within the database interaction component 60. Review means 33 may also review the specifications 21 for consistency (e.g., if the nutritional blend formulation is to be a liquid, has the user specified the use of a substance that is insoluble in the rest of the ingredients) and/or completeness (e.g., has the user specified all the nutrients that would typically be included in a nutritional blend formulation having the specified intended purpose) and/or compatibility (e.g., are the ingredients specified by the user incompatible for any of a number of possible reasons).

Notification means 37 serves to notify the user through the graphical user interface 14, e.g., through template 5 (via template communications means 31), of the results of the review. Based on those results, the user may use modification means 11 to modify the specifications 21 to obviate any problems called to the user's attention by the system. Alternatively, or in addition, the system may itself attempt to correct some or all of the apparent errors, discrepancies, or other deviations from the “rules” in the system where such errors, discrepancies, and deviations are present in or result from the specifications. For example, if the user has directly or indirectly specified use of a nutritional formulation material insoluble in the rest of the nutritional formulation materials, the system may automatically substitute a soluble nutritional formulation material that provides the same nutrient as the insoluble nutritional formulation material.

After identification means 28 identifies available nutritional formulation materials from which the nutritional blend formulation specified by the user may be manufactured, information pertaining to them is selectively retrieved from the database using retrieval means 29, and any suitable retrieval means 29 may be used. Thus, retrieval means 29 may be a database search module, engine, or other structure that acts on parameters, labels, pointers, headings, tags, or other instructions. Retrieval means 29 collects some or all of the required information in the one or more databases 18 pertaining to the available nutritional formulation materials for further use by the system. For example, if the particle size distribution of a particulate formulation is to be determined, the retrieval means would retrieve the particle size distribution information for each of the nutritional formulation materials to be included in the nutritional blend formulation.

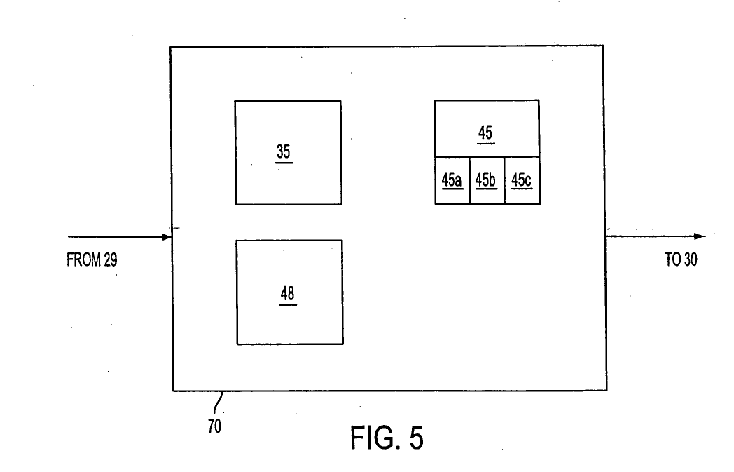

Once the retrieval means 29 retrieves the appropriate information, the information is communicated to processing component 70. As shown in FIG. 5, processing component 70 encompasses various functionalities for further processing the identified and retrieved information. Conversion means 35 converts the information retrieved by retrieval means 29 into formulation product information pertaining to the nutritional blend formulation. Conversion means 35 may utilize one or more conversion algorithms for a number of purposes, e.g., to convert values in the specifications received from the user or as modified by the user or the system (e.g., values in International Units or weight percentages) into the mass of each nutritional formulation material required in the nutritional blend formulation. After all of those masses are determined, processing component 70 can determine what weight percent each is of the entire nutritional blend formulation.

Conversion factors used by the one or more algorithms in conversion means 35 will typically be stored in the one or more databases 18 as part of the information contained at one or more locations within the hierarchy of available nutritional formulation materials, but some of the conversion factors may be stored within the algorithms that use those factors. Thus, for example, to convert from a certain number International Units of activity for a vitamin requires knowledge of the number of International Units per mass or volume of the nutritional formulation material being used to supply that nutrient, and that information is stored in databases 18 for all of the various nutritional formulation materials that could supply that vitamin. Accordingly, after that particular nutritional formulation material has been identified by identification means 28 using hierarchy 23 of types 23a and subtypes 23b of nutritional formulation materials based on the specifications 21 (as received from the user, or as modified by the user or the system, or as supplied by the system) and after retrieval means 29 has retrieved the relevant information for that particular nutritional formulation material from databases 18 (e.g., the number of International Units per mass of the nutritional formulation material), that information is sent to conversion means 35 to perform the conversion. However, the information needed to convert from English units to metric units (e.g., kilograms to pounds) may be located in the one or more required conversion algorithms themselves. Thus, if the user specifies English UOMs (units of measure) but the number of International Units for a vitamin supplied by a nutritional formulation material is stored in databases 18 in metric units (e.g., International Units per gram), the system must also convert between English and metric units). The selection fields on web pages 3 will typically allow only a few different units of measure (UOMs) for the specifications 21, and the formulation product information 55 will typically be reported in UOMs consistent with the UOMs for the specifications 21 (e.g., if English UOMs are used for the specifications, the formulation product information will typically be reported in English UOMs, although the user may vary that).

By way of example, if the user specifies an activity level of 400,000 International Units of vitamin E per unit of nutritional supplement to be added to animal feed and the particular subtype of vitamin E nutritional formulation material identified by the system in accordance with the specifications has 1,000 IU/gram, the conversion means 35 would determine the amount of vitamin E to be 400 grams (400,000 IU divided by 1,000 IU/gram). If the user had also selected a unit of measure for the formulation product information in English units, conversion means 35 would further process 400 grams into a value of approximately 0.88 pounds or 14.1 ounces. One of those two values would then be included in the formulation product information 55 reported to the user through graphical user interface 14 by reporting module 30 for the vitamin E (or more specifically for the nutritional formulation material supplying the vitamin E).

Processing component 70 may also include pricing means 48 for determining the estimated cost of the nutritional blend formulation if made from the available nutritional formulation materials identified by the identification means according to the specifications received through the graphical user interface 14 from the user and for including the estimated cost in the formulation product information reported through the graphical user interface 14 to the user. Pricing means 48 utilizes cost data for the various available nutritional formulation materials in its operations, which cost data are retrieved by the retrieval means from the one or more databases 18. Thus, the amount of each nutritional formulation material determined by conversion means 35 is multiplied by its unit cost (which is the information retrieved from databases 18), after any suitable conversion with respect to mass or volume units, to determine the individual cost of that nutritional formulation material in the nutritional blend formulation. The individual costs of the nutritional formulation materials are totaled (which total may be corrected by proprietary cost factors) to determine a total estimated cost of the nutritional blend formulation. The total cost may be reported as part of the formulation product information to the user through graphical user interface 14 using reporting module 30.

Another functionality encompassed by processing component 70 is physical property estimating means 45 for estimating one or more physical properties of the nutritional blend formulation if manufactured from the available nutritional formulation materials identified by the identification means. Thus, physical property estimating means 45 includes particle size distribution estimating means 45a for estimating the particle size distribution of particulate nutritional blend formulations as well as including density estimating means 45b and viscosity estimating means 45c. Physical property estimating means 45 may contain any other means (45d, 45e, etc.) required for estimating any other physical properties of interest.

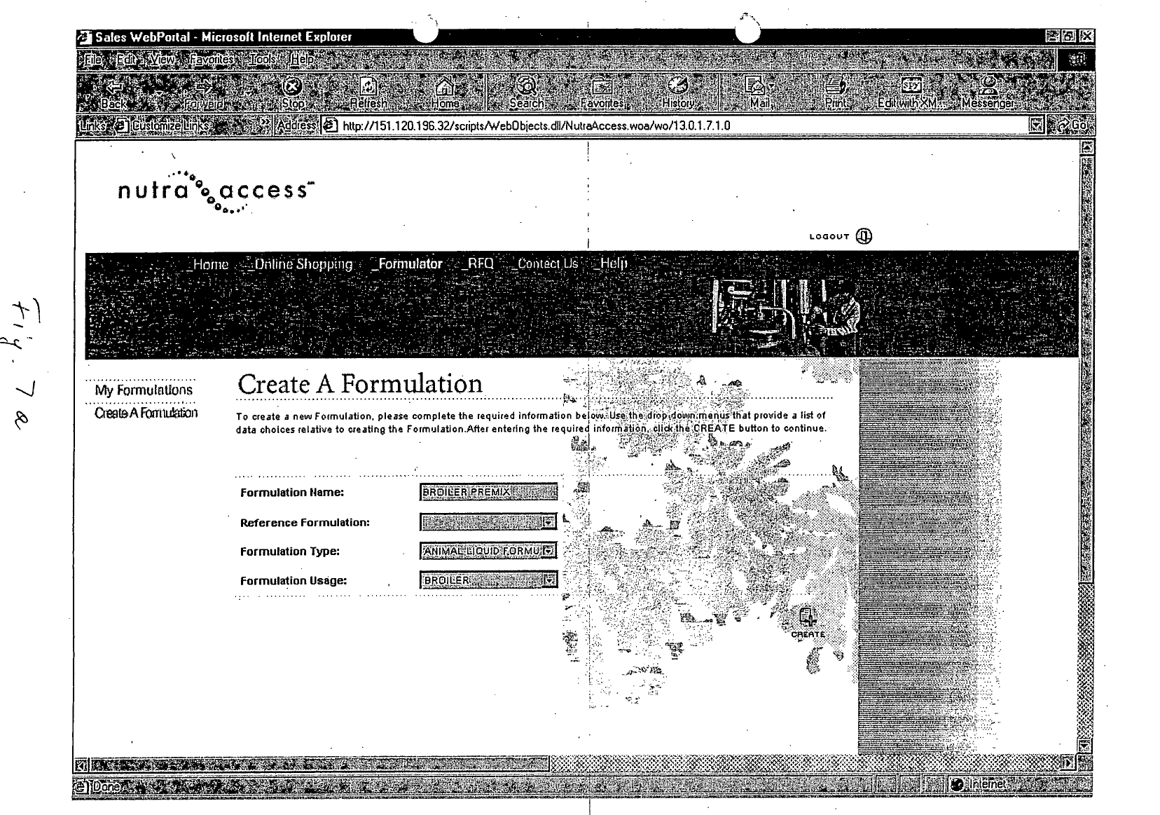

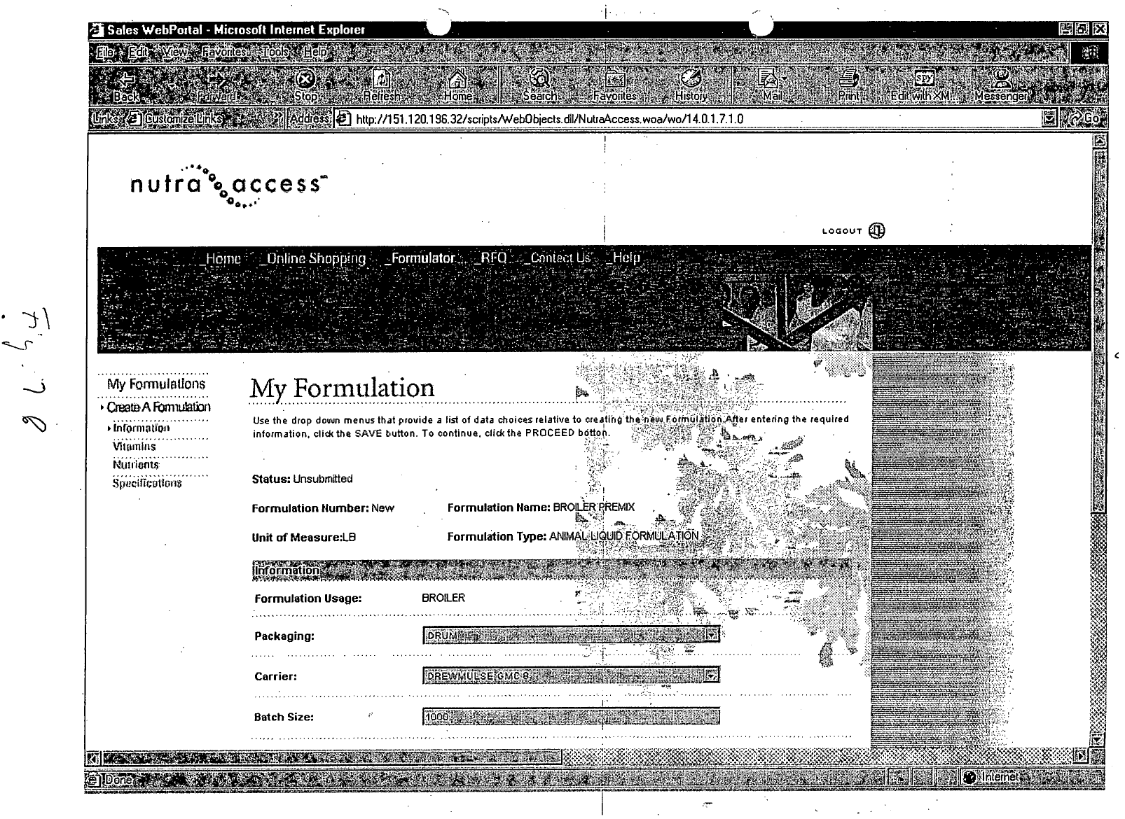

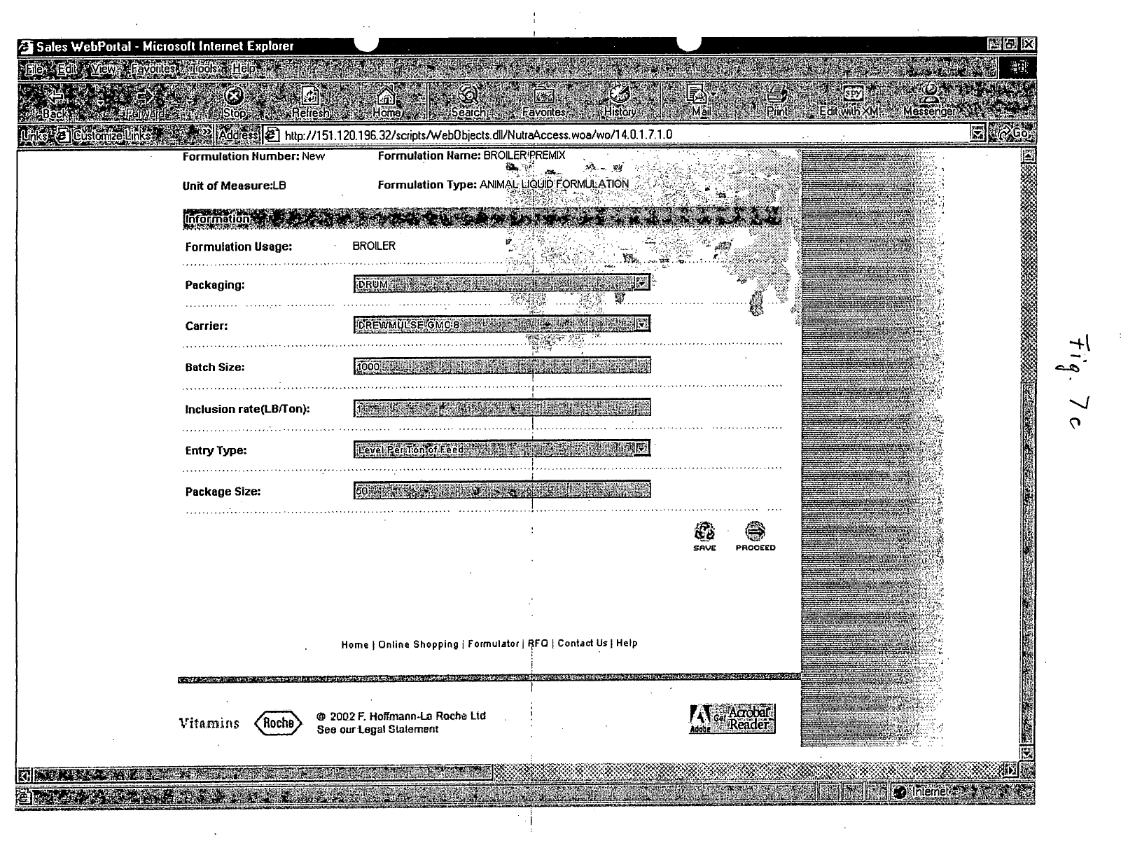

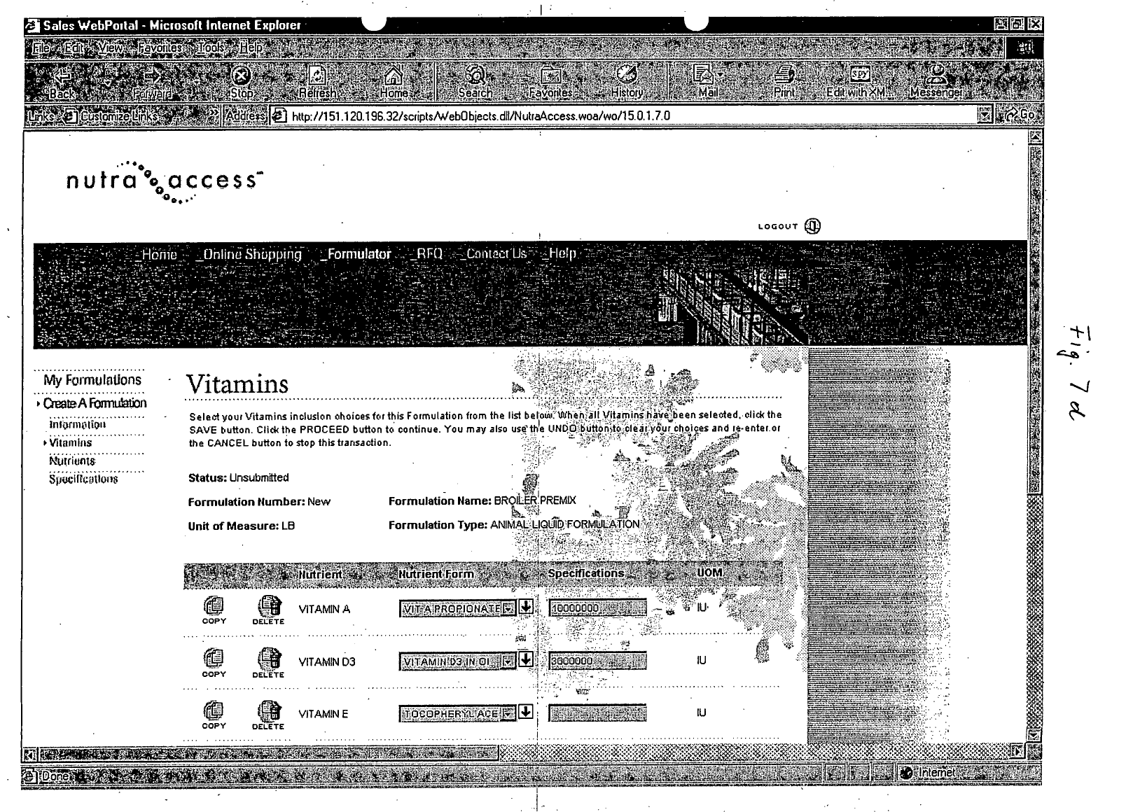

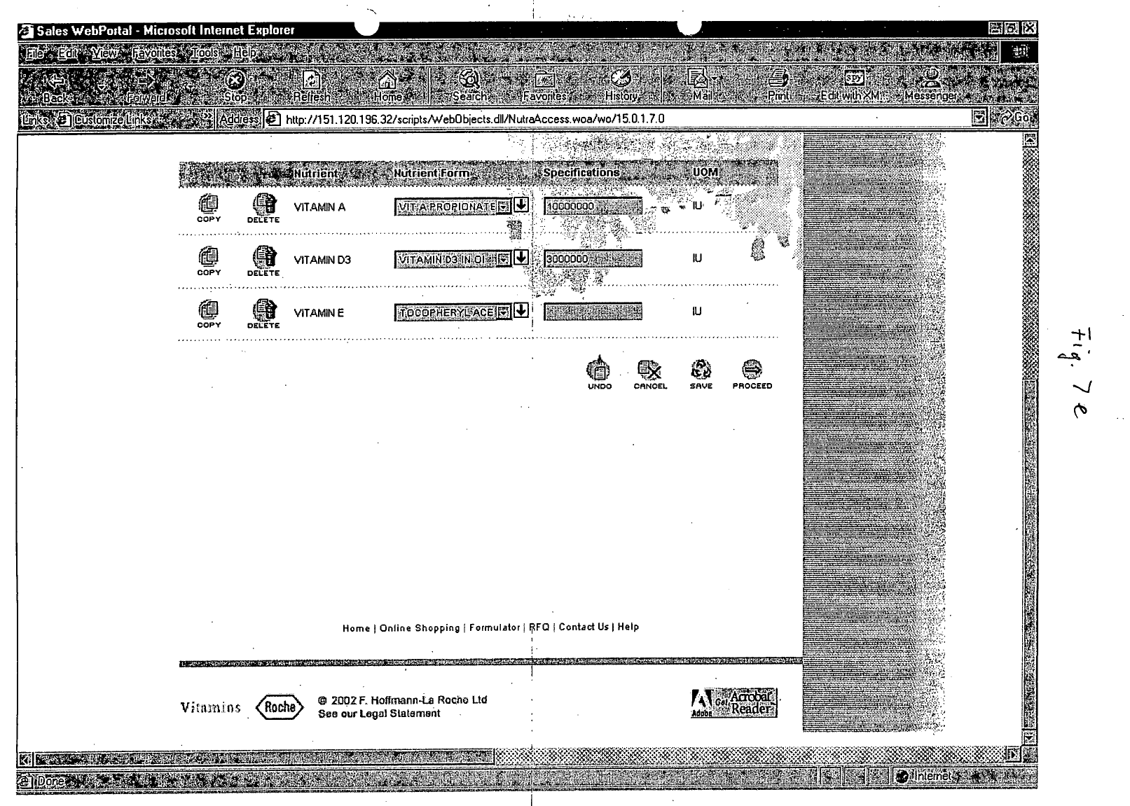

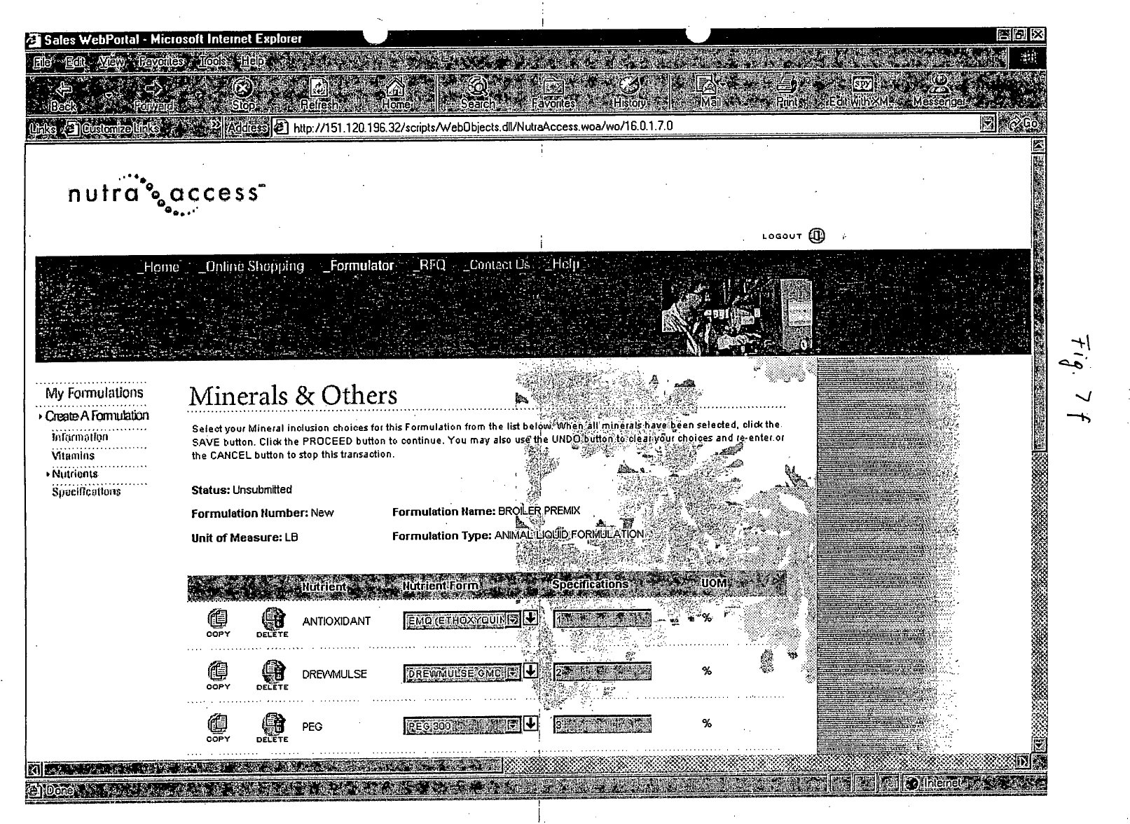

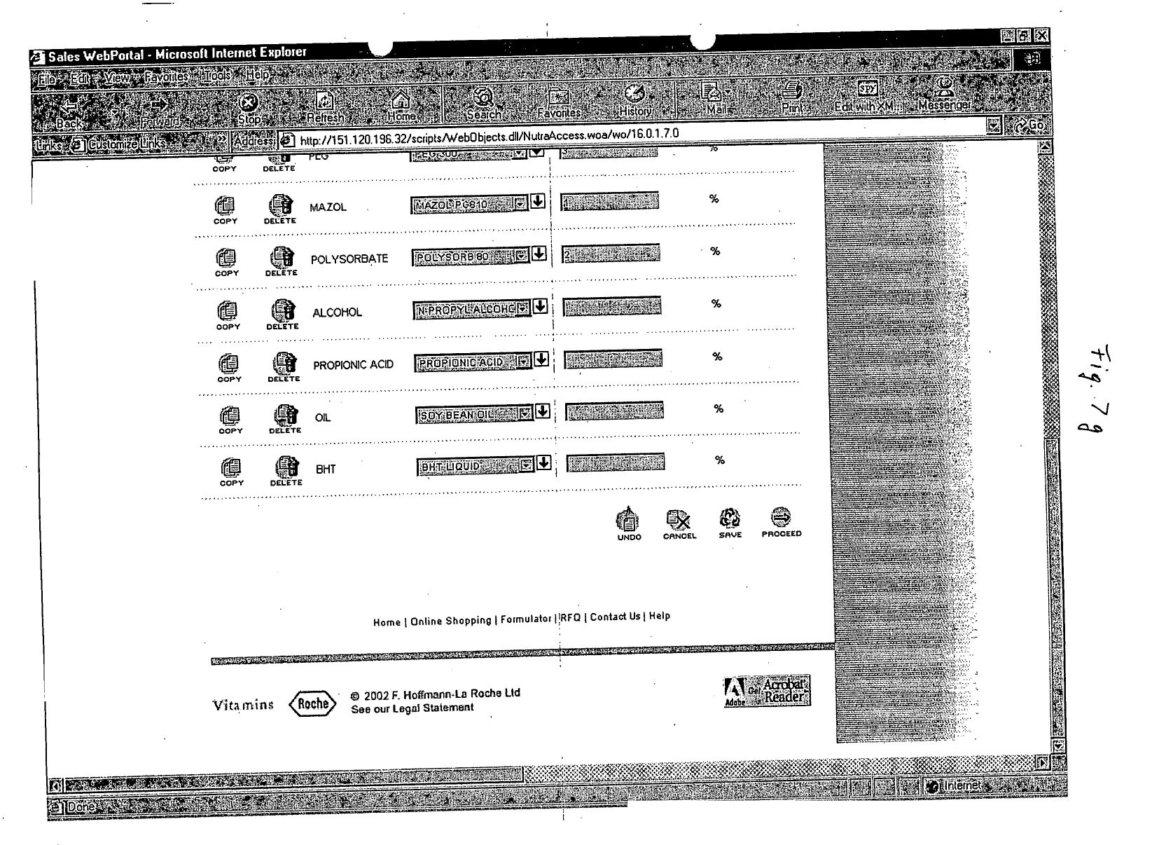

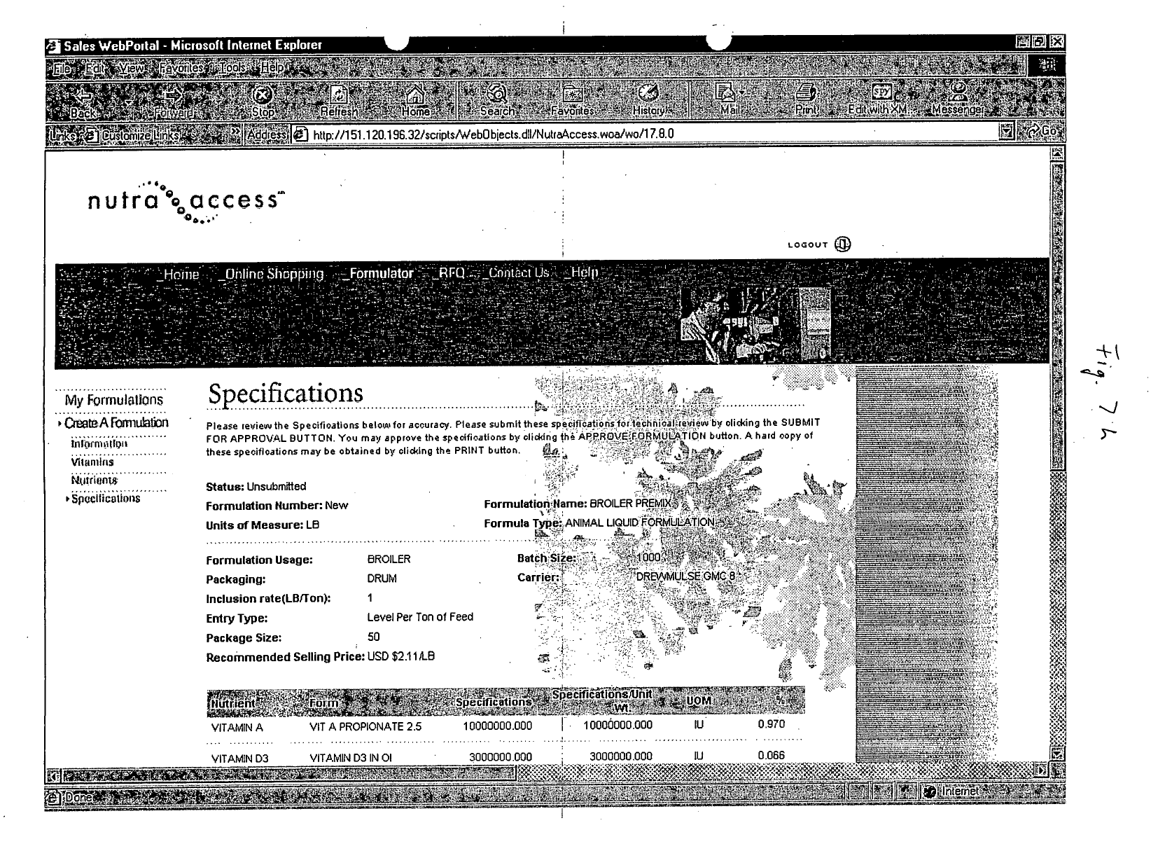

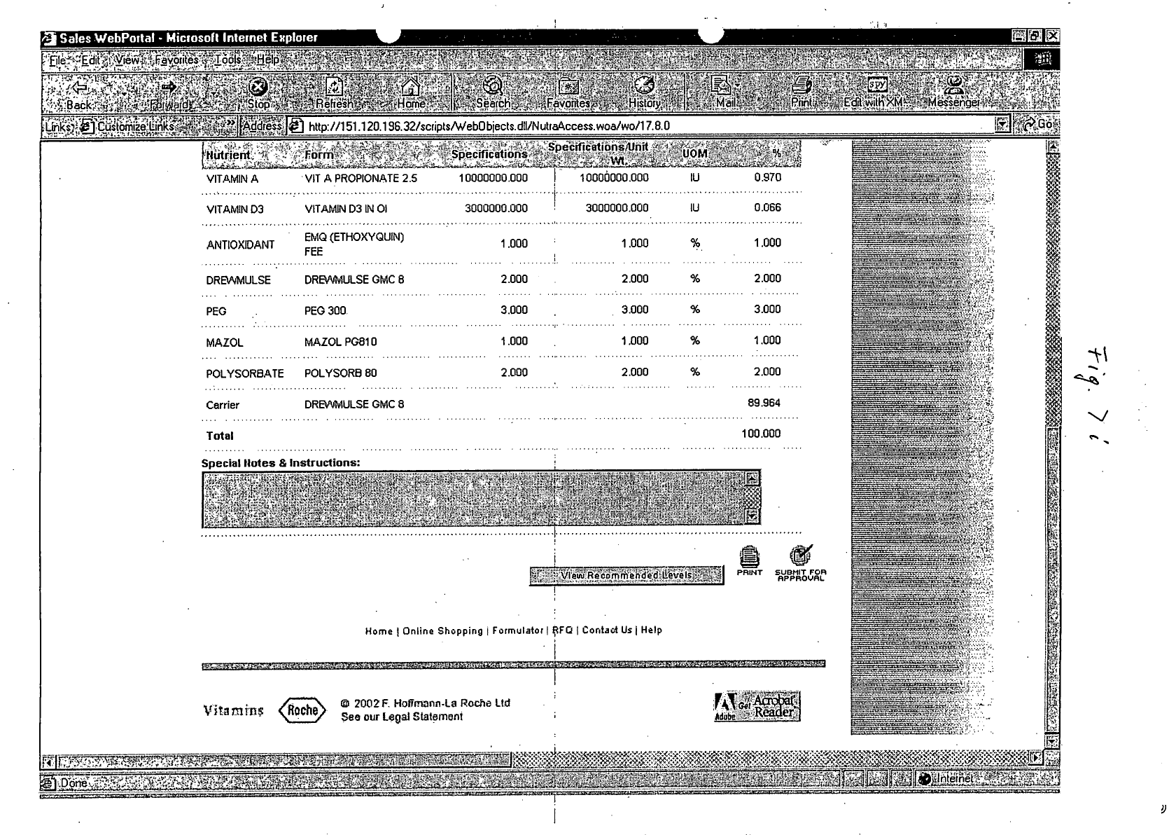

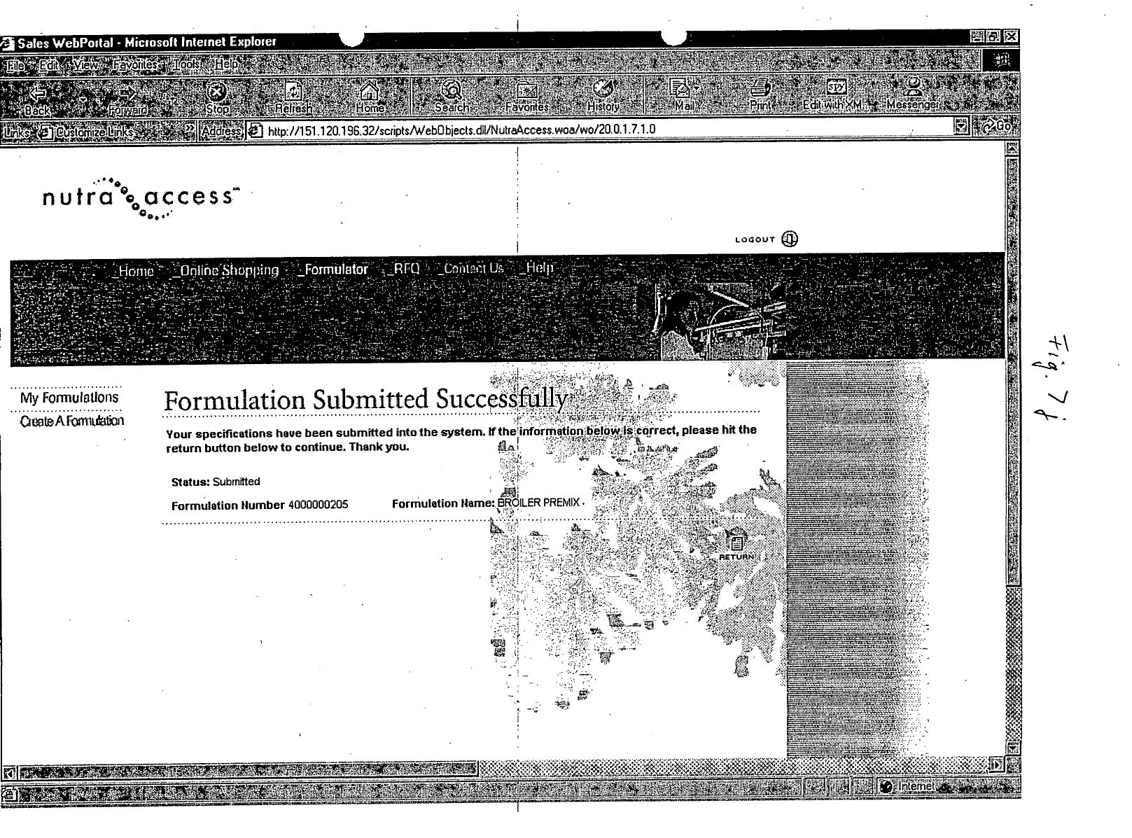

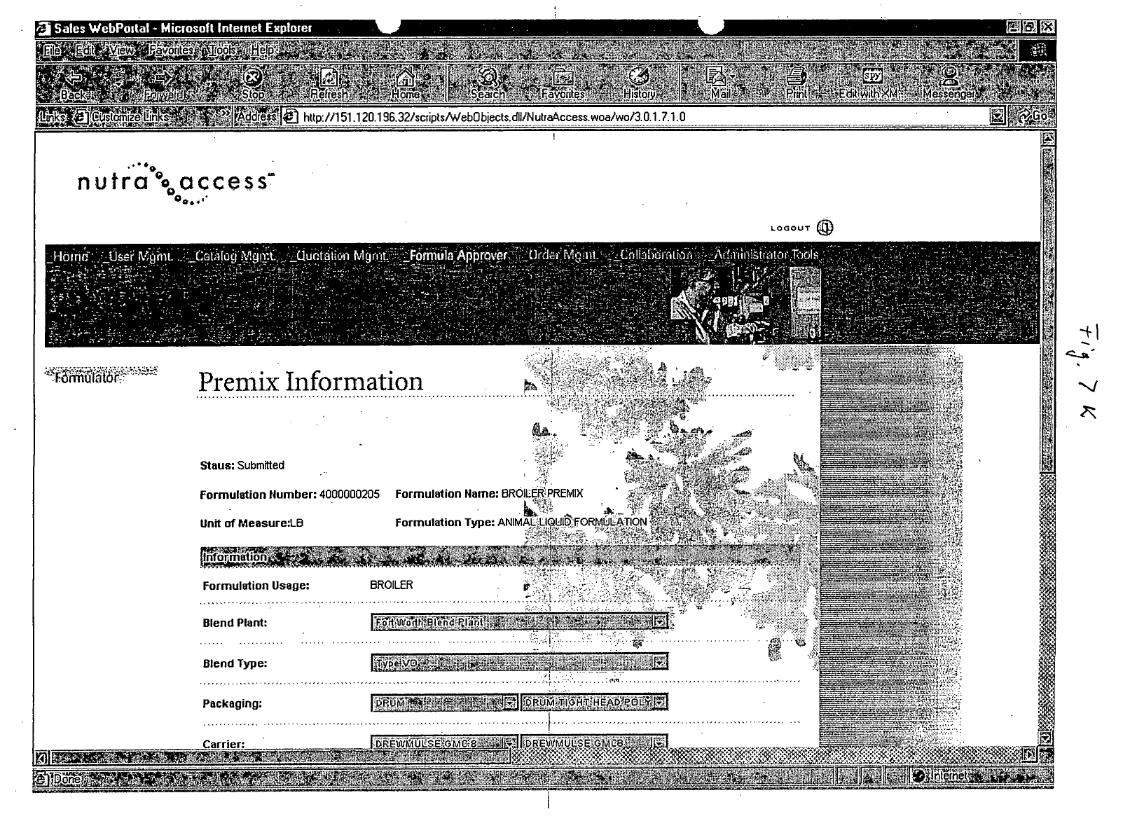

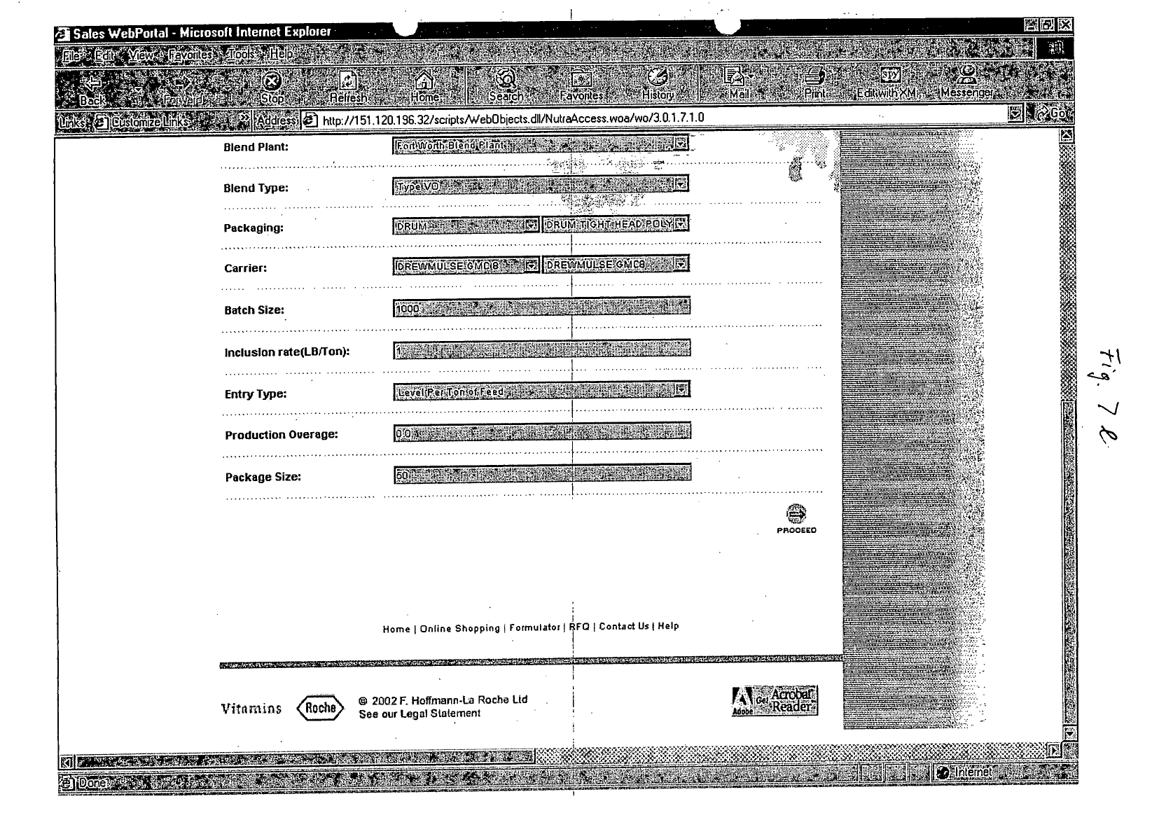

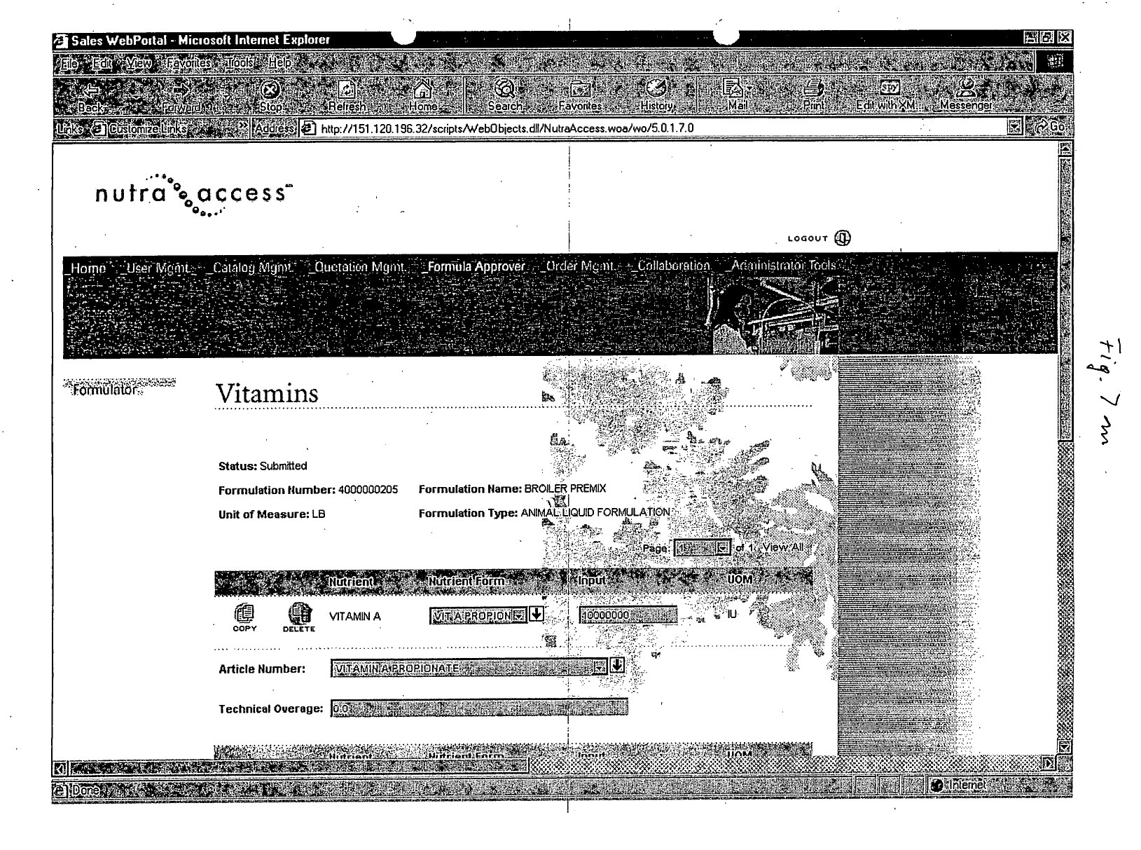

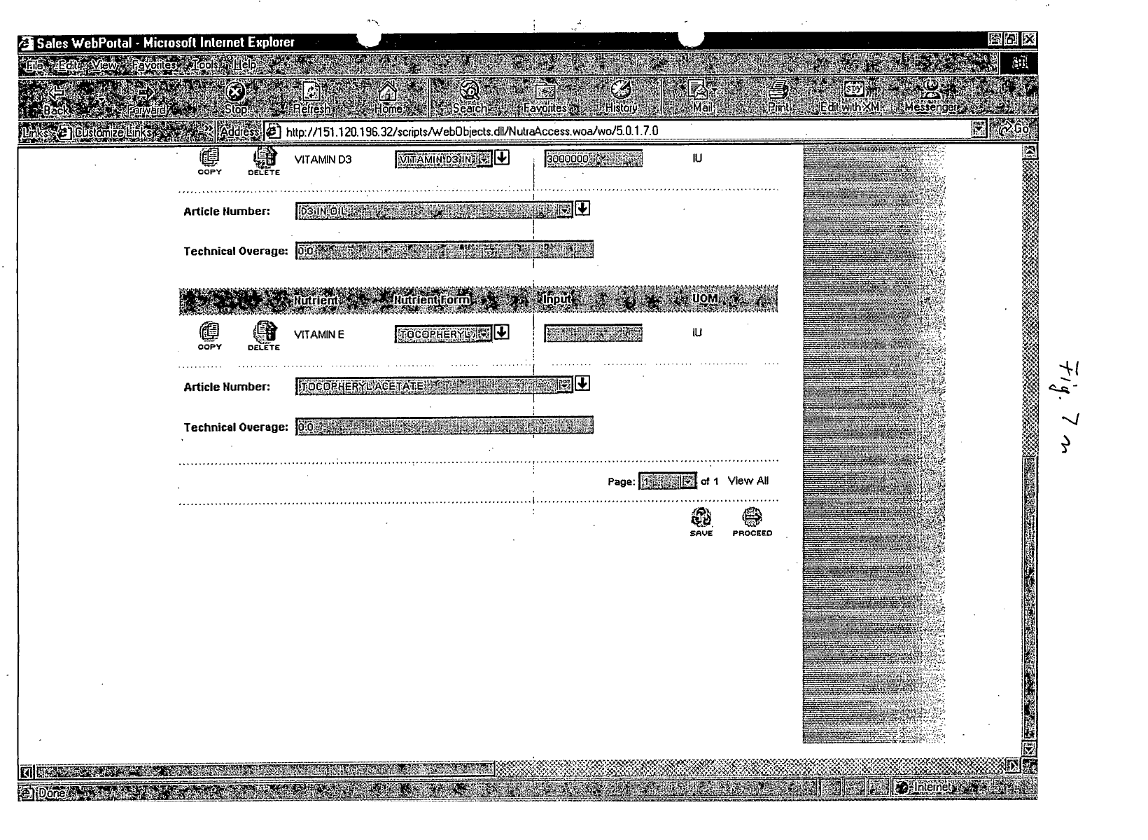

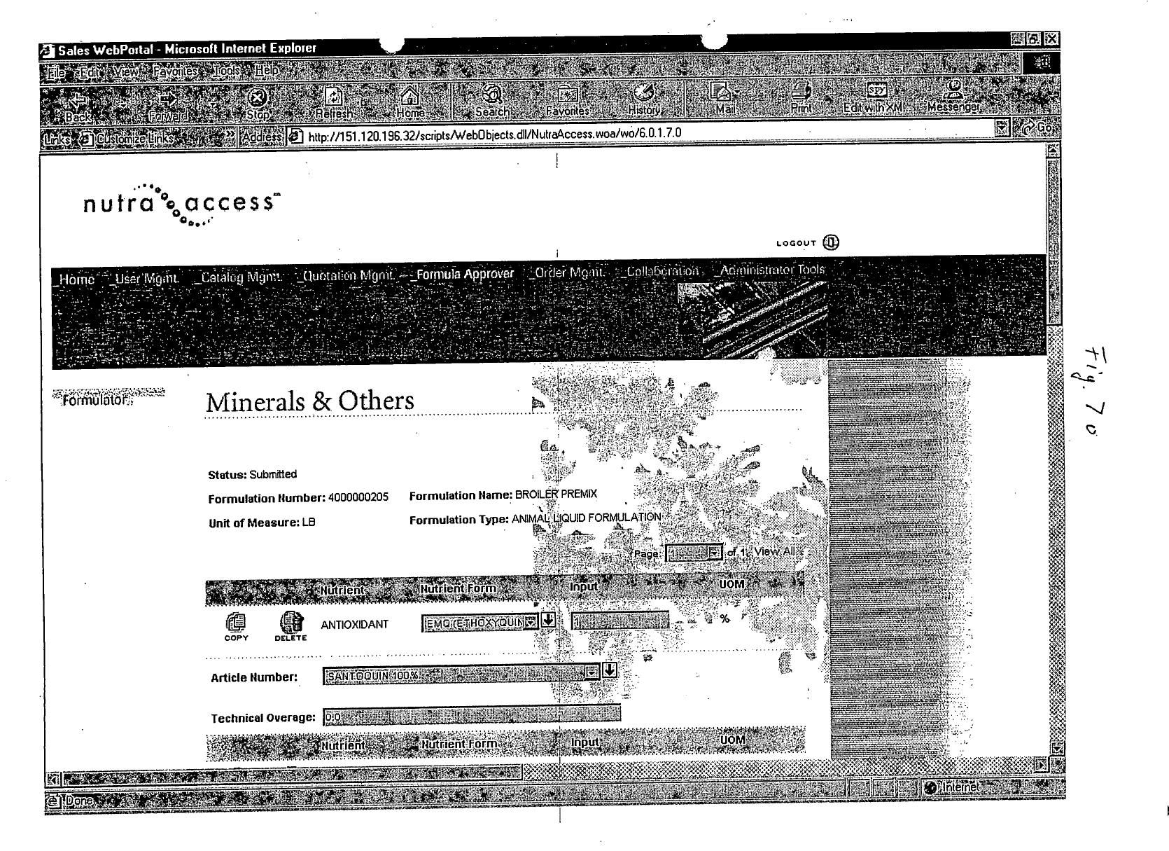

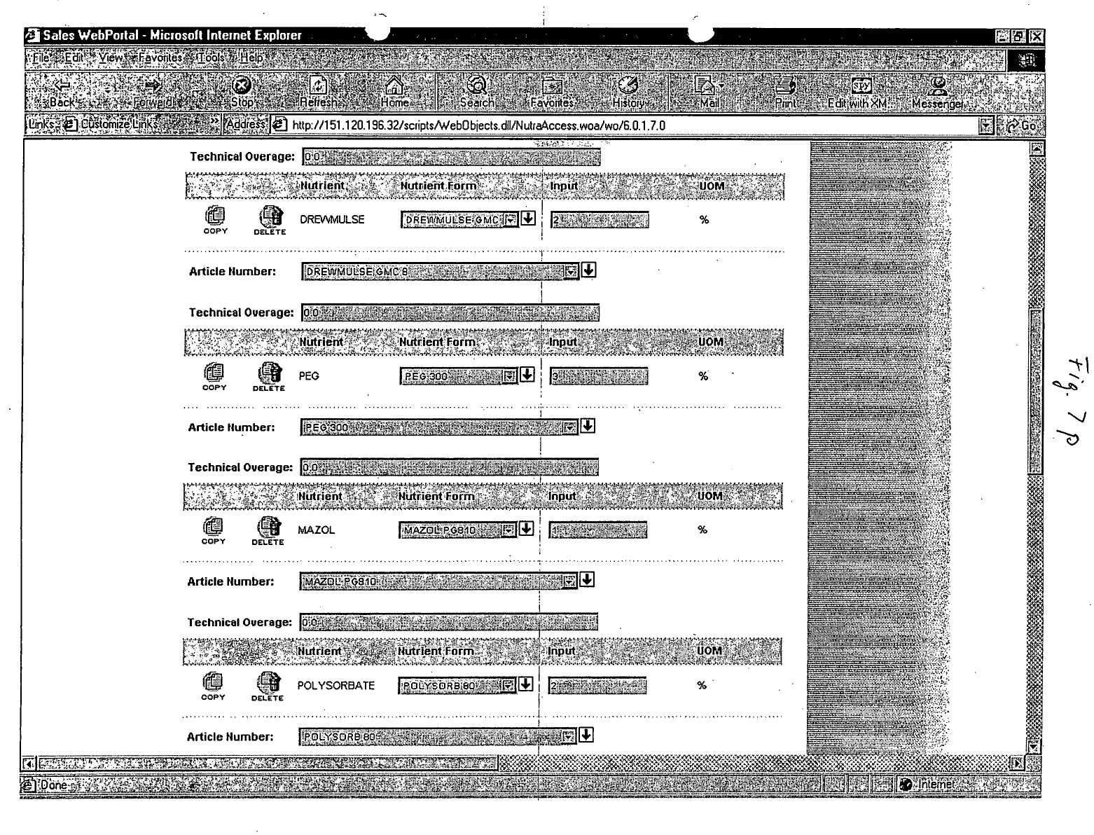

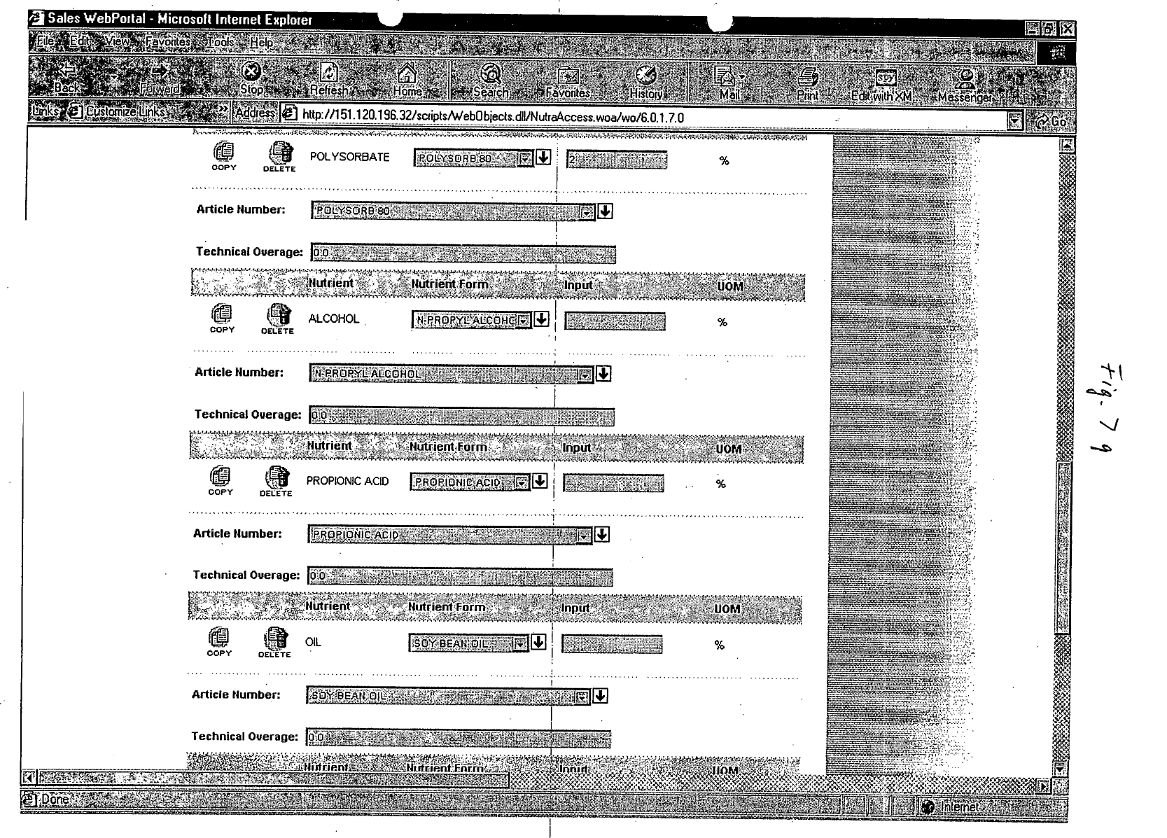

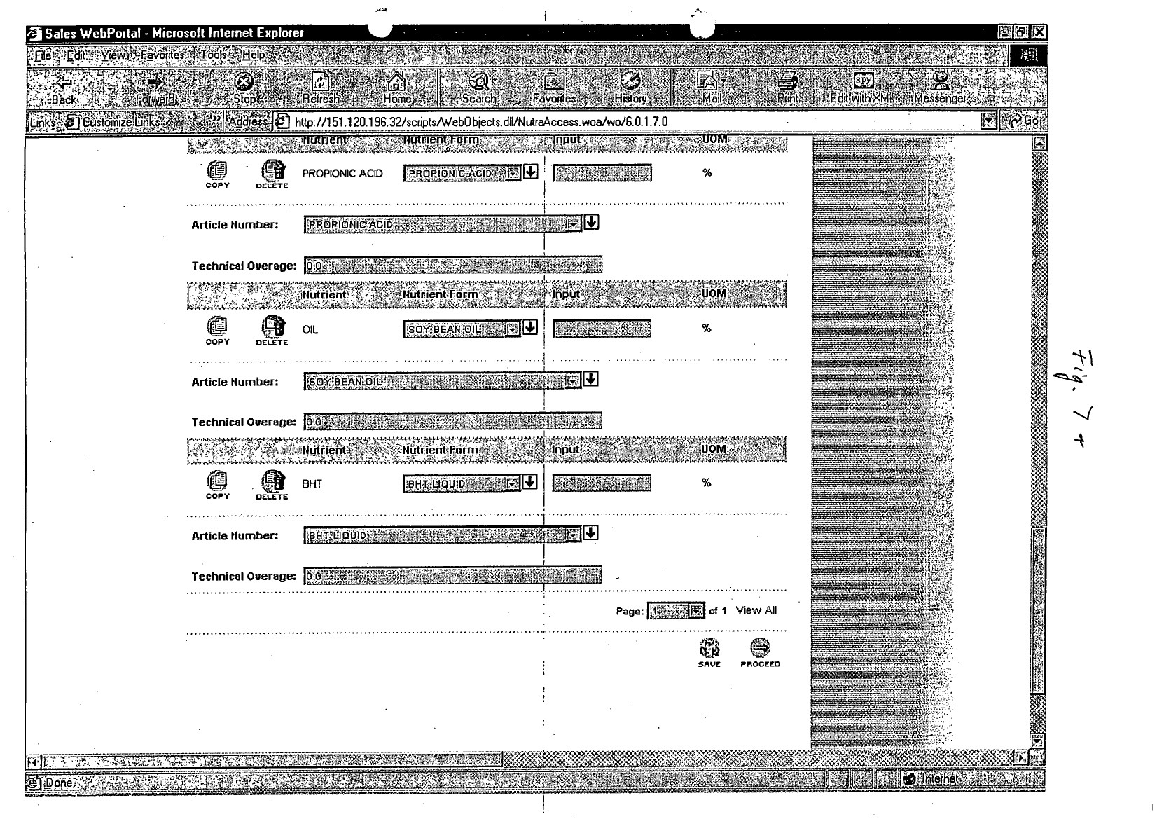

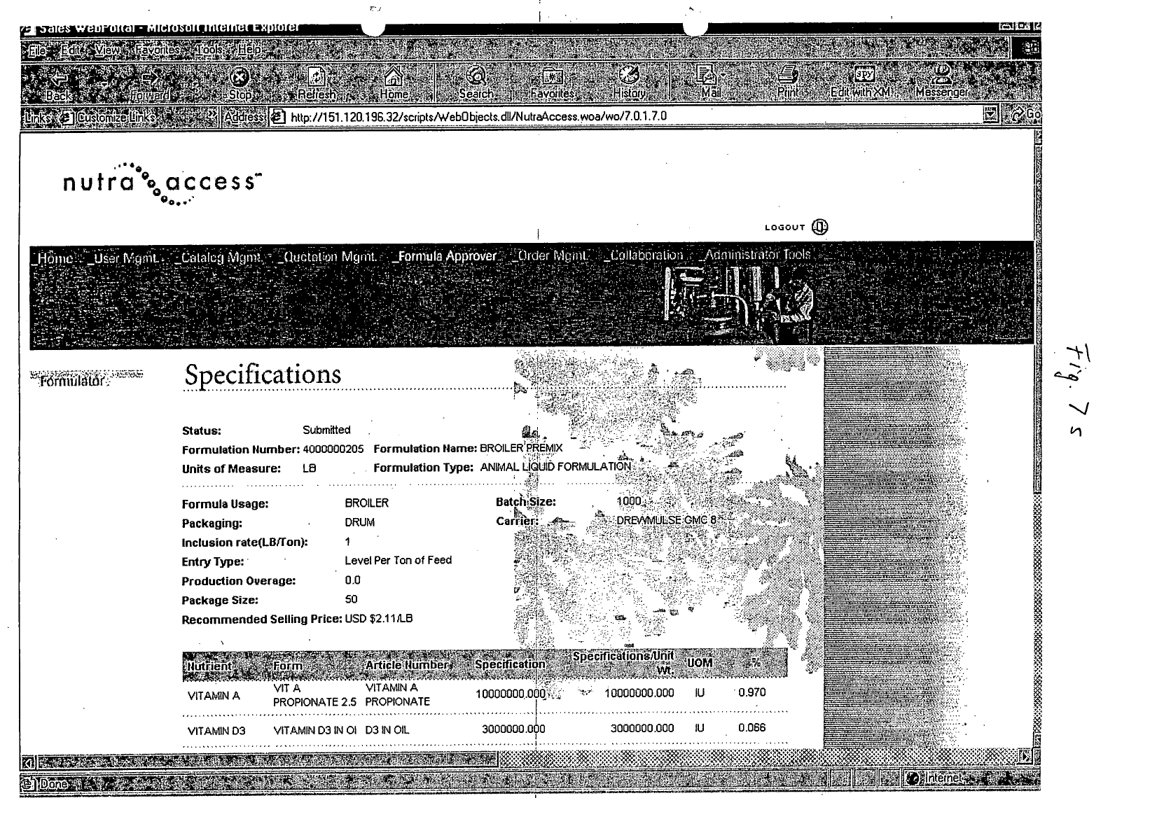

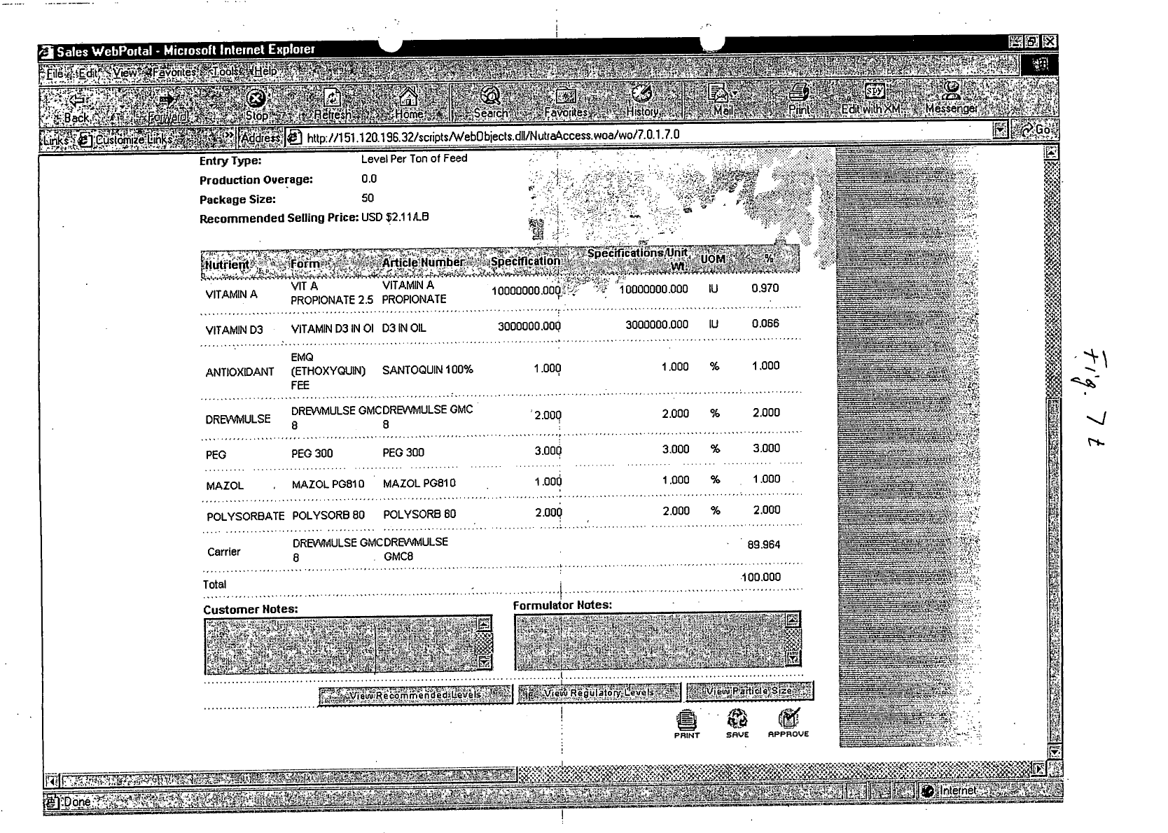

With reference also to FIGS. 1 and 2, reporting module 30 reports the formulation product information 55 determined by processing component 70 from the specifications (using the retrieved information) to the graphical user interface 14 and the user. The formulation product information 55 may be displayed in further web pages 3 in the form of a report to the user illustrating the nutritional blend formulation, its constituents, and its various attributes and properties. The formulation product information will typically include a listing of nutrients and/or nutritional formulation materials in the nutritional blend formulation, any name or other identification assigned to the nutritional blend formulation (e.g., by the user), the physical form of the nutritional blend formulation, its packaging, and its estimated cost. The specifications 21 provided by the user may also be included (e.g., for comparison and modification by the user). Still other formulation product information may be reported to the user (e.g., estimated delivery time). An example of the web page display of formulation product information being displayed to a user appears in FIGS. 7h-7i.

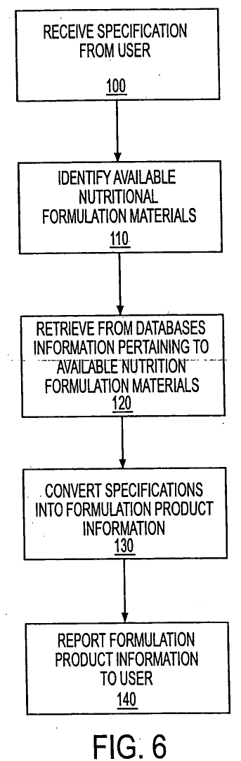

FIG. 6 illustrates the preferred method according to this invention. Specifications are received from the user (100), available nutritional formulation materials are identified (110), information pertaining to the available nutritional formulation materials is retrieved from the databases (120), the specifications are converted into formulation product information using the retrieved information (130), and the formulation product information is reported to the user (140).

Receipt at graphical user interface 14 of formulation product information allows the user to consider that information, which is based upon the specifications the user submitted to the system, prior to the user's ordering the nutritional blend formulation, the user's modifying the specifications for resubmission, etc. Because system 15 can process modified specifications nearly instantaneously in most cases, the user can rapidly determine the effect of making one or more changes in the specifications or other input the user furnishes (which may be referred to as a “what if” analysis) before submitting a proposed nutritional blend formulation for further processing (e.g., submission for review by a formulator, submission to request that a manufacture or vendor make an offer to the user to sell the nutritional blend formulation, submission to request a price quotation from the manufacturer or vendor that is below the estimated cost reported to the user on the graphical user interface, or submission of an offer to buy the nutritional blend formulation at the price reported to the user on the graphical user interface).

The user may choose to make modifications because of curiosity as to the effect that one or more modifications would have on the formulation product information (e.g., how would reducing the activity of a nutrient affect the cost) or as a result of something in the formulation product information being unacceptable (e.g., the estimated price for the nutritional blend formulation being too high, the estimated delivery time of the nutritional blend formulation being too late, or one or more of the physical properties of the nutritional blend formulation being unacceptable) or for any other reason. The user may choose to modify one or more of the specifications at a time (e.g., change the physical form of the nutritional blend formulation from liquid to particulate, increase the concentration of a mineral, decrease the concentration of a vitamin, delete all activity and quantity information from the specifications and allow the system to select all of the quantities based on the specified intended use of the nutritional blend formulation) and/or the user may choose to modify the hierarchy of nutritional formulation materials (e.g., so that a different nutritional formulation material is used to supply a particular nutrient).

As indicated above, the system itself may be capable of making various modifications (e.g., because of apparent errors, discrepancies, or other deviations from the “rules”), and those modifications may be made at any appropriate stage of operation and by any appropriate part of the system. For example, the system may contain means to determine modified specifications for the nutritional blend formulation if the desired nutritional activity and/or concentration for one or more of the nutrients received from the user through the graphical user interface are below the suggested minimum or above the suggested maximum concentration or activity for one or more of the suggested nutrients for the intended use. The system would then use the modified specifications to determine the formulation product information for the modified specifications and report the formulation product information for the modified specifications to the user through the graphical user interface. Thus, in a preferred embodiment, the system contains specification modification means for modifying the specifications for the nutritional blend formulation received from the user through the graphical user interface.

Upon completion of the review of the on-screen information, the user may transmit the formulation product information to another system 50, for instance, the manufacturer's internal computer system, linked on line to system 15. Such transmission to system 50 may be made by any suitable means, for example, on line through the graphical user interface 14 and the reporting module 30. As indicated above, the transmission may be made for any of a number of reasons (e.g., to submit the proposed nutritional blend formulation for review and/or approval by the manufacturer or vendor or by any other entity, e.g., consultants or agents). System 50 may be a simple transmittal system for conveying the information (e.g., to a formulator or a consultant for review and/or approval), or system 50 may be a complex enterprise system that oversees the production systems (e.g., manufacturing plants, raw material ordering systems) and the inventory and billing systems. Such complex enterprise systems form no part of the present invention.

The manufacturer or vendor can review the formulation product information received and can approve or modify the specifications, the nutritional formulation materials to be used, or the formulation product information itself. Such modification may be made for any of a number of reasons, for example, to enhance the effectiveness or reduce the cost of the proposed nutritional blend formulation, to match the user's requirements concerning quantity and desired delivery date to the manufacturer's production schedules, and/or to harmonize the particle size distributions of the various particulate ingredients to try to prevent their stratification (i.e., separation) and resulting non-homogeneity.

The system may be configured to allow the manufacturer or vendor to send back the approved and/or modified nutritional blend formulation (and other pertinent information) to the user via the graphical user interface 14 and/or the reporting module 30 for the user's further review and approval. The system may further be configured to allow the user after such further review and approval to submit the nutritional blend formulation for a price quotation or for manufacture, for instance, through the on line link (e.g., graphical user interface 14 and reporting module 30) to manufacturer's system 50. Alternatively, the user may modify the nutritional blend formulation received from the manufacturer or vendor for further processing by system 15 or for further review by the manufacturer or producer. This process may be continued until the user and manufacturer or vendor are satisfied with the proposed nutritional blend formulation, its price, its delivery date, etc. and, for example, an order is placed for the nutritional blend formulation.

FIGS. 7a through 7t are illustrative screenprints according to a preferred implementation of the system and method of this invention. FIG. 7a shows the first screen (page), which is entitled “Create A Formulation.” The user has given the name “Broiler Premix” to the formulation the user wishes to create and has inserted that name into the box (field) provided for entry of the name. Because there is no earlier formulation the user wishes to use to modify or build upon (i.e., use as a starting point), the box (field) entitled “Reference Formulation” is empty. If there were such an earlier formulation, the user could access that formulation by clicking on the down-pointing arrowhead at the right side of the box (field) and that would cause to be displayed a list on the resulting pull-down menu of the earlier formulations associated with the user (i.e., formulations the user had previously entered into and saved in the system). The user has depressed the arrowhead for the next lower field (“Formulation Type”) to display a pull-down menu and selected “Animal Liquid Formulation” from among the types listed on the menu. The user has also depressed the arrowhead for the lowest field on the screen (page) and selected “Broiler” (i.e., a chicken for broiling) from among the end uses listed in the pull-down menu. The user has pushed the “Create” button in the lower right corner of the screen to continue using the system.

FIGS. 7b and 7c show, respectively, the top and bottom portions of the second screen. The system has accepted and now shows at the top of this second screen the information entered via the first screen (FIG. 7a), namely, that the user is working with a new animal liquid formulation called “Broiler Premix” to be used for broilers. These specifications result in the system selecting the unit of measure (“UOM”) to be “LB” (i.e., pounds). “Unsubmitted” on the status line indicates that the formulation has not yet been submitted to the vendor or manufacturer for approval. This second screen allows the user to enter further information (i.e., additional specifications) concerning the new formulation. Thus, the user has specified that the formulation is to be packaged in 50-gallon drums, that the batch size is 1,000 pounds (e.g., that the user is considering placing an order for 1,000 pounds), that the carrier in the formulation is to be Drewmulse GMC 8 (an ester), and that the inclusion of the premix in the broiler feed is “level per ton of feed” at the rate of 1 pound per ton of the feed. In other words, the user intends to add 1 pound of the premix to 1,999 pounds of feedstock to prepare a ton (2,000 pounds) of the final feed to be fed to the broilers. The user can save the information (specifications) entered so far and/or proceed to the third screen by clicking on the appropriate icon in the lower right of the second screen (FIG. 7c).

FIGS. 7d and 7e show, respectively, the top and bottom of the third screen. This screen indicates to the user that vitamins A, D₃, and E are customarily included in the composition specified by the user and provides fields (boxes) for data entry (in other words, the template provided by the system for the formulation type and/or usage specified by the user indicates that those three vitamins are customarily included). When the screen first appears, the system suggests a nutrient form to be used for each nutrient (i.e., the nutrient form field contains the name of each suggested nutrient form when the screen first appears); however, the user can ignore the suggestion for a particular nutrient form by first clicking on the large down-pointing arrow to the right of the nutrient form field for that nutrient, clicking on the small down-pointing arrowhead that is part of the field, and then selecting a nutrient form from the pull-menu that appears when the small down-pointing arrowhead is clicked on. Clicking on the large down-pointing arrow to the right of a field populates the respective pull-down menu with the names of all of the available nutrient forms for the respective nutrient (including the name of the initially suggested nutrient form), and clicking on the small down-pointing arrowhead causes the entire menu for that nutrient to appear, thereby allowing the user to select a nutrient form from all of those that are available.

The “vitamin A propionate” shown on the screen as the name of the nutrient form for the vitamin A may also be the name of the nutritional formulation material to be used to supply the vitamin A (that may often be the case if there is only one nutritional formulation material for a nutrient form). Alternatively, the vitamin A propionate nutrient form may have two or more sub-types under it and the system will initially chose which of those sub-types to use (i.e., which of the nutritional formulation materials that are vitamin A propionate to use to supply the vitamin A). In either case, after the proposed nutritional blend formulation is submitted for review (e.g., by a master formulator), the reviewer may decide to change the nutrient form or the nutritional formulation material supplying the vitamin A.

In the fields (boxes) to the right of the large down-pointing arrows, under the column heading “Specifications,” the user can key in (enter) the level of inclusion of each nutrient (i.e., the quantity specification for each nutrient). Here, the user has entered 10,000,000 IU for vitamin A, so there will be 10,000,000 International Units (“IU”) of vitamin A in the 1 pound of premix. (The appropriate units, here “IU,” are supplied by the system for each nutrient as part of the template.) Because vitamin A is being supplied in the premix only by the nutrient form specified (i.e., vitamin A propionate) and the feed does not otherwise contain vitamin A, there will 10,000,000 IU of vitamin A in a ton of the feed that is fed to the broilers. The user has also specified 3,000,000 IU for vitamin D₃. Although the template indicates that vitamin E should be present and has recommended a nutrient form for it (tocopheryl acetate), the user has chosen not to include it in the formulation (i.e., the user has left the quantity specification field blank). The system may be designed to prevent the user from failing to include a nutrient that the system recommends be included or to prevent the user from specifying that the nutrient be present at a level less than the minimum level recommended by the system and/or at a level greater than the maximum level recommended by the system. In this case, the system does allow the user to leave the field blank (i.e., specify that no amount of vitamin E be present) even thought the system recommends its inclusion in the composition.

The icons at the left and bottom of the screen allow the user to perform several different operations. The “Copy” icon on the row for a nutrient allows the user to specify a second acceptable nutrient form for supplying that nutrient, thereby allowing the system to choose which of the two nutrient forms to include in the formulation. The “Delete” icon on the row for a nutrient allows the user to delete the quantity specification previously entered by the user for it. The “Undo” icon at the bottom of the screen clears all quantity specifications. The “Cancel” icon allows the user to cancel all of the screens and go back to the initial screen. The “Save” icon allows the user to store the information already entered without proceeding to the next screen (e.g., if the user must temporarily halt what the user is doing). The “Proceed” icon allows the user to go to the next (fourth) screen.

FIGS. 7f and 7g show, respectively, the top and bottom of the fourth screen. As for the vitamins (FIGS. 7d and 7e), the system has, based on the formulation type and/or usage specified by the user, suggested that various minerals and other substances be included in the formulation, and those suggested substances are listed under the column entitled “Nutrient.” The system has also recommended a nutrient form and indicated the unit of measurement (“UOM”) for each of the suggested nutrients. The user has selected, and/or accepted the system's recommendation for, a nutrient form for each nutrient but has not specified any level of inclusion (quantity specification) for several of the nutrients. Thus, the user has specified an antioxidant (EMQ) level of 1%, a Drewmulse level of 2%, a PEG (polyethylene glycol) level of 3%, a Mazol level of 1%, and a Polysorbate level of 2%. The user has not specified any level of inclusion for alcohol, propionic acid, oil, or BHT. Again, the same six icons (“Copy,” “Delete,” “Undo,” “Cancel,”“Save,” and “Proceed” are available and perform the functions discussed above. Clicking on the “Proceed” icon takes the user to the next (fifth) screen.

FIGS. 7h and 7i show, respectively, the top and bottom of the fifth screen. In this screen, the information input by the user (i.e., quantity and other specifications) and the information suggested by the system in response to those specifications are summarized. Thus, all of the vitamins, minerals, and other nutrients for which the user specified non-zero levels of inclusion are listed and next to each nutrient are the nutrient form, quantity specifications input by the user, quantity specifications per unit weight, units of measurement (UOM), and weight percent of the nutrient form in the nutritional blend formulation. The system has calculated a recommended selling price (US $2.11 per pound of premix) and that information is included just above the table (FIG. 7h).

The “specifications per unit weight” are the quantity specifications per unit weight of the premix. In other words, if on the second screen (FIGS. 7b and 7c) the inclusion rate had been 2 pounds per ton (in other words, 2 pounds of premix added to 1,998 pounds of feedstock to prepare a ton (2,000 pounds) of the final feed to be fed to the broilers) and the other specifications had remained unchanged (i.e., the vitamin, mineral, and other nutrient levels specified on the third and fourth screens (FIGS. 7d through 7g)), the specifications per unit weight would be half of the values currently shown in the “Specifications Per Unit Weight” column in FIGS. 7h and 7i. Thus, for example, the 10,000,000 IU of vitamin A (first row in the table of FIGS. 7h-7i) would remain the same in the “Specifications” column but the “Specifications Per Unit Weight”) would be only 5,000,000 IU (i.e., 5,000,000 IU of vitamin A per pound of premix); however, because 2 pounds of premix would be included in each ton of feed, the total specified amount of 10,000,000 IU of vitamin A would still be present in the ton of feed.

After reviewing the quantity and other specifications (FIGS. 7h and 7i), the user can click on icons in the lower right corner of the screen (FIG. 7i) to print the screen and/or to view the nutrient levels recommended by the system for the formulation type and formulation usage specified on the first screen (FIG. 7a). The user can also enter notes and instructions in the field provided (near the bottom of the screen). When the user is satisfied with the specifications and resulting formulation product information for the formulation, including its estimated selling price (and whether or not the user has viewed the recommended levels of nutrients), the user can submit the formulation for approval by clicking on the appropriate icon in the lower right corner of the screen (“Submit For Approval”). Clicking on that icon results in a handshake between the part of the system that helped the user create the proposed nutritional blend formulation and the part of the system that will review or allow review of the proposed formulation. As a result, the specifications entered by the user (quantity specifications, nutrient forms, special notes and instructions, etc.) are transmitted for technical review, e.g., by a formulator.

If the user wishes to change one or more of the pieces of information entered, the user can click on the appropriate link at the left side of the screen (to the left of the title “Specifications”; FIG. 7h). For example, if the user wanted to change the vitamin A level, the user could click on “Vitamins” at the left side of the “Specifications” screen and the system would return the user to the Vitamins screen (i.e., the third screen, shown in FIGS. 7d and 7e). As another example, if the user were on the “Specifications” screen (FIGS. 7h and 7i) and wanted to change the nutrient form supplying the antioxidant, the user would click on “Nutrients” at the left side of the “Specifications” screen (FIG. 7h) and the system would return the user to the fourth screen (FIGS. 7f and 7g) so that the user could modify the nutrient form for the antioxidant.

FIG. 7j shows the screen (i.e., the sixth screen) returned by the system to the user after the user submits the proposed formulation (by clicking on the “Submit For Approval” icon in FIG. 7i). FIG. 7j shows that the status has been changed from “unsubmitted” (e.g., FIG. 7b) to “submitted” and shows the formulation name (“Broiler Premix”) and the accession number assigned to the formulation. (“Formulation Number”), i.e., 4000000205. If the information is correct, the user clicks on the “Return” icon. If the user wishes to change any of the information, the user clicks on “My Formulations” at the left side of the screen and is returned to the first screen (FIG. 7a) so that the user can modify the formulation (the formulation number would be inserted into the “Reference Formulation” screen of FIG. 7a).

FIGS. 7k through 7t show the screens seen by the formulator who will review the proposed formulation. The formulator will typically be an agent of the manufacturer or vendor of the nutritional blend formulation. Some or all of the review may be automated (e.g., using a computer system). Some of the review may occur after the user submits the specifications and before some or all of the formulation product information is generated. Review of the specifications or the formulation product information may be in connection with possible regulatory agency issues (e.g., arising from regulations of the U.S. Food & Drug Administration, the U.S. Federal Trade Commission, or their European or Japanese counterparts), for potential physical and chemical problems (e.g., if the nutritional blend formulation is particulate, is any of the nutrients so different in its particle size distribution from the particle size distributions of the other nutritional formulation materials that it is likely to “separate” from the others and thereby result in non-homogeneity of the mixture), or in connection with other issues (e.g., is there an adequate supply of each of the nutritional formulation materials on which the formulation product information is based, has the user specified the omission of an essential ingredient).

FIGS. 7k and 7l show, respectively, the top and bottom of the seventh screen, which is entitled “Premix Information.” The status of the proposed formulation is “submitted” and formulation number 4000000205 assigned by the system to the broiler premix formulation is shown. The formulator (or the system) has determined that the premix will be manufactured at the Fort Worth Blend Plant. The user selected “drum” for the packaging but the formulator (or the system) has selected the type of drum. This screen also shows the size of the batch to be manufactured, the carrier, etc. When the formulator is satisfied with the formulation product information displayed, the formulator clicks on the “Proceed” icon in the lower right corner of the screen to move to the next screen. If the formulator is not satisfied with the formulation product information, the formulator can click on the down-pointing arrowheads in many of the fields to display menus containing other choices. Almost all of the information displayed can be changed by the formulator (or the system).

FIGS. 7m and 7n show, respectively, the top and bottom of the eighth screen. This screen allows the formulator to review the level and nutrient form input by the user for each of the vitamins as well as the particular nutritional formulation material selected by the system. For example, for vitamin A, the user submitted a value of 10,000,000 IU and vitamin A propionate as the nutrient form, and the system selected a nutritional formulation material (“Article Number”) denominated “vitamin A propionate” to supply the vitamin A (FIG. 7m). If the formulator wishes to change the vitamin A activity level, the nutritional formulation material supplying the vitamin A, or the nutrient form, the formulator can key in a different activity level and/or select alternative nutrient forms and/or article numbers from the respective pull-down menus. There is usually more than one article number (i.e., nutritional formulation material) under each nutrient form. Each article number is at the lowest hierarchical level under each nutrient and often represents a particular batch or lot of the nutritional formulation material. The “Technical Overage” for each nutrient indicates the amount of additional nutritional formulation material supplying that nutrient that the formulator wants to reserve for making the proposed nutritional blend formulation. The Technical Overage may be required because of any of a number of reasons (to provide additional material for quality assurance testing, packing losses, etc.).

The template for this eighth screen (FIGS. 7m and 7n) is determined by the formulation type and formulation usage specified by the user (FIG. 7a). Thus, even though the user specified that the proposed formulation was to contain no vitamin E (FIGS. 7d and 7e), the formulator (or system) may decide that that it should. In that case, the formulator would insert a value into the “Input” box (field) in the vitamin E row (FIG. 7n) and select a nutrient form and/or an article number or accept the nutrient form and/or an article number suggested by the system. When the formulator is satisfied with all the information on the screen, the formulator clicks on the appropriate icon at the lower right corner of the screen (FIG. 7n), which allows the formulator to save any changes the formulator has made on that screen (“Save”) and to stop at that point or proceed to the next screen (“Proceed”).

FIGS. 7o, 7p, 7q, and 7r together show the ninth screen. As for the vitamins screen (the eighth screen, FIGS. 7m and 7n), the template of this ninth screen lists all of the minerals and other nutrients recommended by the system for the user-specified formulation type and formulation usage (FIG. 7a), even if the user has chosen not to include in the proposed formulation one or more of those minerals and other nutrients (by leaving one or more quantity fields blank). The formulator reviews each of the items and can change the nutrient form, quantity, or article number. For example, for the antioxidant (FIG. 7o), the user submitted EMQ at a concentration level of 1% and the system selected Santoquin 100% as the article (i.e., nutritional formulation material). If the formulator wishes to change any of those, the formulator can overwrite the concentration level and/or select a different nutrient form and/or article number from the respective pull-down menus. The formulator can provide for technical overage by overwriting the “0.0” value with an appropriate numerical value. The formulator can also add to the formulation a material omitted by the user. For example, the proposed nutritional blend formulation submitted by the user does not contain any alcohol (FIG. 7q). If the formulator believes the nutritional blend formulation should contain some, the formulator can insert a non-zero numerical value into the appropriate “Input” box (field) and can adjust the nutrient form and article (nutritional formulation material). When the formulator is satisfied with the contents of this screen, the formulator clicks on the icons at the lower right corner of the screen (FIG. 7r), which allows the formulator to save any changes the formulator has made on that screen (“Save”) and to stop at that point or proceed to the next screen (“Proceed”).

FIGS. 7s and 7t show, respectively, the top and bottom of the tenth screen. This screen shows the specifications for the formulation input by the user as modified by the formulator, which was assigned number 4000000205. For each nutrient to be included in the proposed nutritional blend formulation, the following information is listed: the nutrient form (column labeled “Form”), the nutritional formulation material (column labeled “Article Number”) that will supply the nutrient, the specification (quantity specification), the specification per unit weight of the nutritional blend formulation, the units of measurement (column labeled “UOM”), and the weight percent of the nutrient form (or nutritional formulation material) in the nutritional blend formulation (column labeled “%”). The screen also shows the identifying and shipping information as well as a suggested price (US $2.11 per pound of premix).

At the bottom (FIG. 7t), the screen provides space for user (customer) notes, which were previously entered by the user (FIG. 7i), as well as space for notes to be added by the formulator. Below these spaces for notes are three icons that allow the formulator to view the levels of the various ingredients recommended by the system (based on the formulation type and usage input on the first screen (FIG. 7a)), and/or view levels prescribed by any applicable governmental or other regulations, and/or view particle size distribution information (for a particulate nutritional blend formulation). The formulator can print the screen by clicking on the “Print” icon at the bottom right of the screen and the formulator can save the information by clicking on the “Save” icon (also at the bottom right of the screen).

When the formulator is satisfied with all features of the proposed formulation (including, for example, the estimated price, the particle size distribution, and the nutritional formulation materials to be used), the formulator clicks on the “Approve” icon. That sends the formulation information to a second approval level (e.g., approval by a supervisor). Once the vendor is satisfied with the formulation (i.e., after it has been approved at the second approval level), the status of the formulation is changed to indicate that it has been so approved and the user is so notified (e.g., by email). The user then re-enters the system (e.g., through the graphical user interface and via the Internet), retrieves the formulation information (as modified and approved by vendor), reviews the formulation product information (including estimated price, final specifications, etc.), and makes any further changes the user wishes to make. For example, the formulator may have added a nutrient that the user does not wish to have present in the premix. In that case, the user would communicate with the formulator and explain the basis for the exclusion of that nutrient and resubmit revised specifications omitting that nutrient.

When the user and vendor (at all approval levels) are satisfied, the proposed formulation can be entered into the vendor's or manufacturer's records. That might involve entering the formulation into a master system such as an enterprise system that contains tracking, raw material ordering, accounting, billing, production scheduling, and other systems. At this point, a final quotation (including a firm offer price) can be given to user (e.g., by email, by telephone, and/or through the graphical user interface of the system). If the user accepts (i.e., places an order), the master system (e.g., enterprise system) so indicates in the appropriate systems and the nutritional blend formulation is released for manufacture, billing, etc.

In the specific embodiment of FIGS. 7a-7t, the nutrient form may be thought of as being the “type” of nutrient and the article number may be thought of as being the “sub-type” under the type. Thus, for example, with reference to FIG. 7o, in the hierarchical scheme, the antioxidant nutrient has below it in the hierarchy the EMQ nutrient form, which in turn has below it the Santoquin 100% article number, and the Santoquin 100% is a nutritional formulation material at the lowest hierarchical level (and will supply the antioxidant nutrient).

As will be understood by one skilled in the art, the invention has been illustrated and described herein (including the drawings) with reference to specific embodiments. However, as will also be understood by one of ordinary skill in the art, various modifications may be made in what has been described without departing from the scope of the invention as set forth in the claims. Accordingly, all such modifications are, and are intended to be, included within the scope of the claimed invention.

We claim:

1. A computerized system for assisting users to determine, evaluate, and/or place orders for nutritional blend formulations to be manufactured from available nutritional formulation materials, each nutritional blend formulation comprising a plurality of nutrients, the system comprising:
(a) a web-accessible graphical user interface (i) for receiving from a user, and communicating over the web to one or more other parts of the system, specifications for a nutritional blend formulation, the specifications including the intended use of the formulation from among a plurality of possible intended uses and/or the desired nutritional activity and/or concentration of one or more of the nutrients in the formulation, and (ii) for receiving through the web from one or more other parts of the system, and reporting to the user, formulation product information determined by one or more other parts of the system pertaining to that nutritional blend formulation;
(b) one or more databases of information pertaining to the available nutritional formulation materials from which the nutritional blend formulations can be prepared, the one or more available nutritional formulation materials for each nutrient being organized into a hierarchy of types and optionally one or more subtypes within each type, the hierarchy of types and subtypes facilitating the identification of the available nutritional formulation materials for the nutritional blend formulation specified by the user;
(c) identification means for identifying, using the hierarchy of types and subtypes, the available nutritional formulation materials from which the nutritional blend formulation specified by the user can be manufactured;
(d) retrieval means for selectively retrieving from the one or more databases at least some of the information pertaining to the available nutritional formulation materials identified by the identification means;
(e) conversion means for converting the specifications into formulation product information pertaining to the nutritional blend formulation using the retrieved information, the conversion means including means for determining the quantities and/or activities of the available nutritional formulation materials to be included in the nutritional blend formulation needed to satisfy the specifications specified by the user; and
(f) a reporting module for reporting the formulation product information, including the quantities and/or activities determined by the conversion means, through the graphical user interface to the user.

2. The system of claim 1 further comprising a suggested nutrient database identifying a group of suggested nutrients for each of one or more of the intended uses.

3. The system of claim 2 further comprising template communications means for communicating to the user through the graphical user interface the group of suggested nutrients for the intended use of the nutritional blend formulation received from the user through the graphical user interface.

4. The system of claim 0.3 further comprising means for preventing the user from including in the specifications for the nutritional blend formulation received through the graphical user interface a desired nutritional activity and/or concentration for any nutrient not in the group of suggested nutrients.

5. The system of claim 1 further comprising a suggested nutrient database identifying a group of suggested nutrients for each of one or more of the intended uses and suggested minimum and/or maximum concentrations and/or activities for one or more of the suggested nutrients for one or more of the intended uses.

6. The system of claim 5 further comprising template communications means for communicating to the user through the graphical user interface (a) the group of suggested nutrients for the intended use of the nutritional blend formulation received from the user through the graphical user interface and (b) the suggested minimum and/or maximum concentrations and/or activities for one or more of the suggested nutrients for the intended use.

7. The system of claim 6 further comprising means for preventing the user from including in the specifications for the nutritional blend formulation received through the graphical user interface a desired nutritional activity and/or concentration for any nutrient not in the group of suggested nutrients for the intended use.

8. The system of claim 6 further comprising concentration/activity notification means for notifying the user through the graphical user interface if the desired nutritional activity and/or concentration for one or more of the nutrients received from the user through the graphical user interface are below the suggested minimum or above the suggested maximum concentration or activity for one or more of the suggested nutrients for the intended use.

9. The system of claim 1 further comprising means to communicate to the user through the graphical user interface at least a portion of the hierarchy of the available nutritional formulation materials for one or more of the nutrients in the nutritional blend formulation received from the user through the graphical user interface.

10. The system of claim 1 wherein the hierarchy of the available nutritional formulation materials for one or more of the nutrients in the nutritional blend formulation received from the user through the graphical user interface is modifiable and the system further comprises means to allow the user through the graphical user interface to modify the hierarchy.

11. The system of claim 1 wherein the one or more databases of information pertaining to the available nutritional formulation materials are modifiable and the system further comprises means to modify the databases.

12. The system of claim 1 further comprising specification modification means for modifying the specifications for the nutritional blend formulation received from the user through the graphical user interface.

13. The system of claim 1 further comprising means for allowing the user to modify the specifications for the nutritional blend formulation received from the user through the graphical user interface by making one or more modifications at a time to determine the effect of making such modifications on the formulation product information reported to the user through the graphical user interface.

14. The system of claim 5 further comprising means for the system (a) to determine modified specifications for the nutritional blend formulation if the desired nutritional activity and/or concentration for one or more of the nutrients received from the user through the graphical user interface are below the suggested minimum or above the suggested maximum concentration or activity for one or more of the suggested nutrients for the intended use, (b) to determine the formulation product information for the modified specifications, and (c) to report the formulation product information for the modified specifications to the user through the graphical user interface.

15. The system of claim 1 further comprising pricing means (a) for determining the estimated cost of the nutritional blend formulation if made from the available nutritional formulation materials identified by the identification means according to the specifications received through the graphical user interface from the user and (b) for including the estimated cost in the formulation product information reported through the graphical user interface to the user.

16. The system of claim 13 further comprising pricing means (a) for determining the estimated cost of the nutritional blend formulation if made from the available nutritional formulation materials identified by the identification means according to the modified specifications and (b) for including the estimated cost in the formulation product information reported through the graphical user interface to the user.

17. The system of claim 14 further comprising pricing means (a) for determining the estimated cost of the nutritional blend formulation if made from the available nutritional formulation materials identified by the identification means according to the modified specifications and (b) for including the estimated cost in the formulation product information reported through the graphical user interface to the user.

18. The system of claim 1 further comprising review means for reviewing the specifications received through the graphical user interface from the user, including the desired nutritional activity and/or concentration of the nutrients in the nutritional blend formulation, for compliance with regulatory agency regulations and/or for consistency and/or completeness and/or compatibility.

19. The system of claim 13 further comprising review means for reviewing the modified specifications for compliance with regulatory agency regulations and/or for consistency and/or completeness and/or compatibility.

20. The system of claim 14 further comprising review means for reviewing the modified specifications for compliance with regulatory agency regulations and/or for consistency and or completeness and/or compatibility.

21. The system of claim 18 further comprising means for notifying the user through the graphical user interface of the results of the review.

22. The system of claim 19 further comprising means for notifying the user through the graphical user interface of the results of the review.

23. The system of claim 20 further comprising means for notifying the user through the graphical user interface of the results of the review.

24. The system of claim 1 further comprising means for estimating one or more physical properties of the nutritional blend formulation if manufactured from the available nutritional formulation materials identified by the identification means.

25. The system of claim 10 further comprising means for estimating one or more physical properties of the nutritional blend formulation if manufactured from the available nutritional formulation materials identified by the identification means using the modified hierarchy.

26. The system of claim 24 further comprising particle size distribution estimating means for estimating, in the case of a nutritional blend formulation in particulate form, the particle size distribution of the particles of the nutritional blend formulation.

27. The system of claim 25 further comprising particle size distribution estimating means for estimating, in the case of a nutritional blend formulation in particulate form, the particle size distribution of the particles of the nutritional blend formulation.

28. The system of claim 1 further comprising-approval means to allow the user to approve the nutritional blend formulation for manufacture.

29. The system of claim 13 further comprising approval means to allow the user to approve the nutritional blend formulation with the modified specifications for manufacture.

30. The system of claim 14 further comprising approval means to allow the user to approve the nutritional blend formulation with the modified specifications for manufacture.

31. The system of claim 28 further comprising formulation product information review means for allowing review of the nutritional blend formulation after it has been approved for manufacture.

32. The system of claim 29 further comprising formulation product information review means for allowing review of the nutritional blend formulation after it has been approved for manufacture.

33. The system of claim 30 further comprising formulation product information review means for allowing review of the nutritional blend formulation after it has been approved for manufacture.

34. The system of claim 28 further comprising means to transmit the nutritional blend formulation and/or its corresponding formulation product information to another system to allow the nutritional blend formulation to be manufactured.

35. The system of claim 29 further comprising means to transmit the nutritional blend formulation and/or its corresponding formulation product information to another system to allow the nutritional blend formulation to be manufactured.

36. The system of claim 30 further comprising means to transmit the nutritional blend formulation and/or its corresponding formulation product information to another system to allow the nutritional blend formulation to be manufactured.

37. A computerized method for assisting users to determine, evaluate, and/or place orders for nutritional blend formulations to be manufactured from available nutritional formulation materials, each nutritional blend formulation comprising a plurality of nutrients, the method comprising the steps:
(a) having available for use the system of claim 1;
(b) through the web-accessible graphical user interface (i) receiving from a user, and communicating over the web to one or more other parts of the system, specifications for a nutritional blend formulation, the specifications including the intended use of the formulation from among a plurality of possible intended uses and/or the desired nutritional activity and/or concentration of one or more of the nutrients in the formulation, and (ii) receiving through the web from one or more other parts of the system, and reporting to the user, formulation product information determined by one or more other parts of the system pertaining to that nutritional blend formulation;
(c) identifying, using the identification means and the hierarchy of types and subtypes, the available nutritional formulation materials from which the nutritional blend formulation specified by the user can be manufactured;
(d) selectively retrieving from the one or more databases of information pertaining to the available nutritional formulation materials at least some of the information pertaining to the available nutritional formulation materials identified in step (c);
(e) converting the specifications into formulation product information pertaining to the nutritional blend formulation using the information retrieved in step (d), the formulation product information including the quantities and/or activities of the available nutritional formulation materials to be included in the nutritional blend formulation needed to satisfy the specifications specified by the user; and
(f) reporting the formulation product information determined in step (e) through the graphical user interface to the user.

38. The method of claim 37 further comprising communicating to the user through the graphical user interface a group of suggested nutrients for the intended use.

39. The method of claim 37 further comprising communicating to the user through the graphical user interface (a) a group of suggested nutrients for the intended use of the nutritional blend formulation received from the user through the graphical user interface and (b) suggested minimum and/or maximum concentrations and/or activities for one or more of the suggested nutrients for the intended use.

40. The method of claim 39 further comprising notifying the user through the graphical user interface if the desired nutritional activity and/or concentration for one or more of the nutrients received from the user through the graphical user interface are below the suggested minimum or above the suggested maximum concentration or activity for one or more of the suggested nutrients for the intended use.

41. The method of claim 37 further comprising communicating to the user through the graphical user interface at least a portion of the hierarchy of the available nutritional formulation materials for one or more of the nutrients in the nutritional blend formulation received from the user through the graphical user interface.

42. The method of claim 41 further comprising allowing the user through the graphical user interface to modify the hierarchy.

43. The method of claim 37 further comprising modifying the databases of information pertaining to the available nutritional formulation materials from which the nutritional blend formulations can be prepared.

44. The method of claim 37 further comprising modifying, or allowing the user to modify, the specifications for the nutritional blend formulation received from the user through the graphical user interface.

45. The method of claim 37 further comprising (a) determining the estimated cost of the nutritional blend formulation if made from the identified available nutritional formulation materials and (b) including the estimated cost in the formulation product information reported through the graphical user interface to the user.

46. The method of claim 44 further comprising (a) determining the estimated cost of the nutritional blend formulation if made from the available nutritional formulation materials corresponding to the modified specifications and (b) including the estimated cost in the formulation product information reported through the graphical user interface to the user.

47. The method of claim 37 further comprising reviewing the specifications received through the graphical user interface from the user, including the desired nutritional activity and/or concentration of the nutrients in the nutritional blend formulation, for compliance with regulatory agency regulations and/or for consistency and/or completeness and/or compatibility.

48. The method of claim 44 further comprising reviewing the modified specifications for compliance with regulatory agency regulations and/or for consistency and/or completeness and/or compatibility.

49. The method of claim 37 further comprising estimating one or more physical properties of the nutritional blend formulation if manufactured from the available nutritional formulation materials identified by the identification means.

50. The method of claim 42 further comprising estimating one or more physical properties of the nutritional blend formulation if manufactured from the available nutritional formulation materials identified by the identification means using the modified hierarchy.

51. The method of claim 49 further comprising estimating, in the case of a nutritional blend formulation in particulate form, the particle size distribution of the particles of the nutritional blend formulation.

52. The method of claim 50 further comprising estimating, in the case of a nutritional blend formulation in particulate form, the particle size distribution of the particles of the nutritional blend formulation.

53. The method of claim 37 further comprising allowing the user to approve the nutritional blend formulation for manufacture.

54. The method of claim 44 further comprising allowing the user to approve the nutritional blend formulation with the modified specifications for manufacture.

55. The method of claim 53 further comprising allowing review of the nutritional blend formulation after it has been approved for manufacture.

56. The method of claim 54 further comprising allowing review of the nutritional blend formulation after it has been approved for manufacture.

57. The method of claim 53 further comprising transmitting the nutritional blend formulation and/or its corresponding formulation product information to another system to allow the nutritional blend formulation to be manufactured.

58. The method of claim 54 further comprising transmitting the nutritional blend formulation and/or its corresponding formulation product information to another system to allow the nutritional blend formulation to be manufactured.
